(19) United States
(12) Patent Application Publication
(10) Pub. No.: US 2011/0128618 A1
(43) Pub. Date: Jun. 2, 2011

(54) GLASS PRODUCTS WITH A SATIN-MATTE FINISH AND METHODS FOR THE PRODUCTION AND USE THEREOF

(76) Inventor: Juan Luis Rendon Granados, Guanajuato (MX)

(21) Appl. No.: 12/867,039

(22) PCT Filed: Oct. 19, 2009
(86) PCT No.: PCT/MX2009/000114

§ 371 Date: Jan. 18, 2011

(30) Foreign Application Priority Data
Feb. 24, 2009 (MX) MX/A/2009/002067

(51) Int. Cl. G02B 5/22; B32B 17/00; B32B 33/00; C03C 15/00

(52) U.S. Cl. 359/361; 428/141; 216/31

(57) ABSTRACT

Satin-matte finish glass products having a uniform finish perfectly homogeneous, a soft and smooth touch with a pleasant aspect to the eye are disclosed and described. Such products may in some aspects have finish characteristics defined by values of transmittance, absorbance, reflectance, roughness and a series of micrographs taken with an atomic force microscope to see the morphology and structure of satin-glass.

### FIELD OF THE INVENTION

The present invention relates to a satin-matte finish glass on either one or both faces, either in whole or in part. The glass may be produced by the process of MX Patent 258791, which is incorporated herein by reference. The resulting satin-matte finish glass in some aspects may have a uniform finish perfectly homogeneous, a soft and smooth touch, with a pleasant aspect to the eye, and can have defined values of transmittance, absorbance, reflectance, and roughness as measured by a series of micrographs taken with an atomic force microscope to show the morphology, structure, and other physical characteristics of the glass.

### BACKGROUND OF THE INVENTION

Nowadays there are different types of satin-matte finish glass, but none of these has the characteristics of the satin-nuanced glass by one or both faces, in whole or in part, produced by the process of MX patent 258,791.

For the production of satin-matte finish glass by the traditional method it is by placing a piece of glass on a special table to reveal only the top surface of the glass, being this the atmospheric face and putting in a peripheral edge of wax, put on it a paste or acid solution to achieve the satin-matte finish; acids are left to act for a while and then removed by a final wash to the piece of glass to remove acids, being treated only one piece by time, the resulting finished is not uniform in the treated face. Through this procedure it is not possible to treat the stained face of the sheet of glass, because the residues attached to this side can not attack the standard solutions used.

The documents US2002139474, U.S. Pat. No. 6,071,314, US2003127189, U.S. Pat. No. 6,228,211, KR20040087386 (ABSTRACT) KR20030073230 (ABSTRACT) DE29917354U, ES2021250, U.S. Pat. No. 1,529,239, GB190628679, WO0190015, GB1276550, U.S. Pat. No. 4,086,074 and JP1102401 describe processes, compositions, and glasses, but all of these are different to the process and glass of the present invention.

The satiny glasses of the present invention have surprising properties that not found in other glasses. These properties are obtained by the manufacturing process of the present invention. These glasses are not satin or suggested in advance, so they are considered to be new and inventive.

### SUMMARY OF THE INVENTION

In one aspect, the present invention provides a satin-matte finish glass that has a uniform finished perfectly homogeneous, a soft and smooth touch with a pleasant aspect to the eye. The finish of the glass products of the present invention may in some aspects be defined using values of transmittance, absorbance, reflectance, roughness and/or a series of micrographs taken with an atomic force microscope to see the morphology and structure of glass-satin, along with some of their physical characteristics.

In some aspects the glass product may have a finish with a roughness Ra of 1.04 to 4.07 and a roughness Rz of 6.7 to 23.2 and a (%) of transmittance, a (%) Absorbance and (%) Reflectance.

These satin-matte finish glass are useful in the glass industry and construction.

### BRIEF DESCRIPTION OF FIGURES

FIGS. 1 to 12 represent the graphical Transmittance (%) and Reflectance (%) respectively of the samples (2-1) to (15) of the present invention, in values of wavelength.

FIGS. 13 to 22 represent the photographs of the measurements that were performed in a scanning electron microscope of samples 2, 2-1, 3, 3A, 5, 5A, 6, 6A, 7, 7A, 9, 9A, 10, 10A, 13, 13A, 14, 14A, 15 and 15A respectively of the present invention, in which there is a uniform finished perfectly homogeneous, a soft and smooth touch with a pleasant aspect to the eye.

FIGS. 23 to 47 represent the graphs of transmittance, absorbance and reflectance of the examples of satin glass 1 to 25 of this invention, in values of wavelength (from values of 350, 352, 354 increasing values of 2 by two until 1200 and values from 0 to 100 in the other axis of the graph).

FIG. 48 represents a graph of the variation of % transmittance at a wavelength of 540 of a clear satin glass by both faces at different thicknesses.

FIG. 49 represents a graph of the variation of % transmittance at a wavelength of 1100 of a clear satin glass on the atmospheric face at different thicknesses.

FIG. 50 represents a graph of the average of the % transmittance at a wavelength of 900 to 1200 of a clear satin glass of 2 mm, by both faces, atmospheric face and stained face. FIG. 51 represents a graph of the variation of the % transmittance at a wavelength of 540 from different satin glasses by the atmospheric face to a thickness of 6 mm.

FIG. 52 represents a graph of the variation of % transmittance at a wavelength of 1100, of different satin glasses by a stained face satin at a thickness of 6 mm.

FIG. 53 represents a graph of the variation of % transmittance at a wavelength of 1100 of a clear satin glass by both faces at different thicknesses.

FIG. 54 represents a graph of the variation of % transmittance at a wavelength of 540 of a clear satin glass by a stained face at different thicknesses.

FIG. 55 represents a graph of the variation of % transmittance at a wavelength of 540, of different satin glass by both faces to a thickness of 6 mm.

FIG. 56 represents a graph of the variation of % transmittance at a wavelength of 1100 of different satin glasses by an atmospheric face at a thickness of 6 mm.

FIG. 57 represents a graph of the variation of % transmittance at a wavelength of 540 of a clear satin glass, by an atmospheric face at different thicknesses.

FIG. 58 represents a graph of the variation of % transmittance at a wavelength of 1100 of a clear satin glass, by an stained face at different thicknesses.

FIG. 59 represents a graph of the variation of % transmittance at a wavelength of 1100 of different satin glasses, by both faces to a thickness of 6 mm.

FIG. 60 represents a graph of the variation of % transmittance at a wavelength of 540 different glasses, by a stained face at a thickness of 6 mm.

### DESCRIPTION OF THE INVENTION

The present invention relates to a satin-matte finish glass by one or both faces, in whole or in part, produced by the process of MX Patent 258791, the resulting satin-matte finish glass, has a uniform finished perfectly homogeneous, a soft and smooth touch, with a pleasant aspect to the eye. With defined values of transmittance, absorbance, reflectance, roughness and a series of micrographs taken with an atomic force microscope to see the morphology and structure of satin glass, furthermore some of their most important physical characteristics.

The satin-matte finish glass by one or both faces, in whole or in part, is the product obtained by the chemical process for satin-matte finish by one or both faces in full or partial sheets of glass by immersion in acid solution to simultaneous and continuous production of the MX patent 258,791, which is incorporated herein by reference.

The satin-matte finish glass by one or both faces, in whole or in part, is obtained from flat sheets of glass of any thickness, color and size of the sheets of glass.

Characteristics of the satin-matte finish glass of the present invention to overcome the satin-matte finish glass sheets produced by other methods and whose treatment satin-matte finish can be done only by one face of the sheet of glass.

Flat glass sheets which are used, are complete sheets of commercial sizes from 180×160 cm, up to 3600×2600 cm, including special measures and thicknesses ranging from 2 mm to 19 mm, as well as different colors of glass like clear, green, gray, blue, brown, amber, rose, polarized, filtersun, etc., which satin-matte finished treatment is done on a face (indifferently tined or atmospheric face), or simultaneously on both faces, in total form (the entire face or faces of the sheet of glass) or in part (such as pictures, prints, stripes, etc.) achieved a very uniform finish in comparison with the uneven finish by only one face by other methods and in addition obtaining a lower cost.

To the satin-matte finish glass by one or both faces, in whole or in part, of this invention were conducted several tests of transmittance, absorbance, reflectance, roughness and a series of micrographs taken with an atomic force microscope to see the morphology and structure of the satin glass, furthermore some of their most important physical characteristics.

In table A below, is showed the samples of satin-matte finish glass, to be tested for transmittance, absorbance, reflectance, roughness and a series of micrographs taken with an atomic force microscope to see the morphology and structure of the satin-matte finish glass of the present invention.

TABLE A
Identification of characterized samples

| | Face where | | |
|---|---|---|---|
| | the measurement | | |
| | was taken | | |
| Sample # | Stained | Atmospheric | Type of glass |
| 2-1 | X | | Clear 9.5 mm SM by |
| 2 | | X | both faces |
| 3 | X | | Filtersun 3 mm SM by |
| 3A | | X | both faces |
| 4 | X | | Clear 2 mm SM by |
| 4A | | X | both faces |
| 5 | X | | Clear 3 mm SM by |
| 5A | | X | both faces |
| 6 | X | | Clear 6 mm SM by |
| 6A | | X | both faces |
| 7 | X | | Green 6 mm SM by |
| 7A | | X | both faces |
| 8 | X | | Filtersun 6 mm SM by |
| 8A | | X | two faces |
| 9 | | X | Bronze 6 mm SM by |
| 9A | X | | both faces |
| 10 | X | | Blue 6 mm SM by |
| 10A | | X | both faces |
| 11 | | X | SI |
| 11A | X | | |
| 12 | | X | SI |
| 12A | X | | |
| 13 | X | | Clear 4 mm SM by |
| 13A | | X | both faces |
| 14 | X | | Clear 4 mm SM stained face |
| 14A | | X | Clear 4 mm doesn't treated |
| | | | atmospheric face |
| 15 | | X | Clear 4 mm SM atmospheric |
| | | | face |
| 15A | X | | Clear 4 mm doesn't treated |
| | | | stained face |

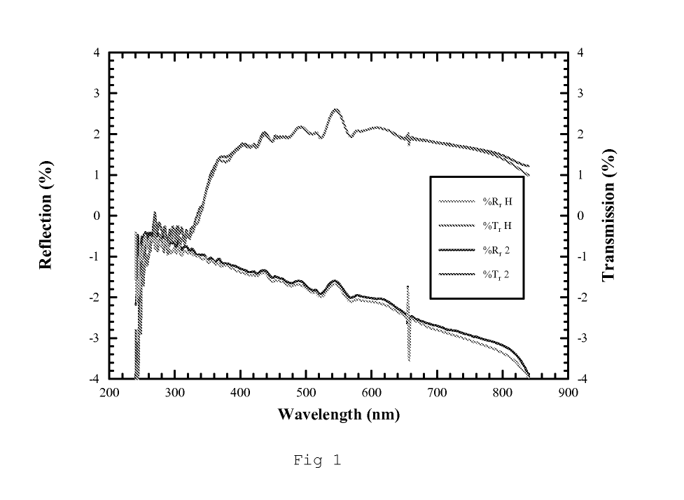

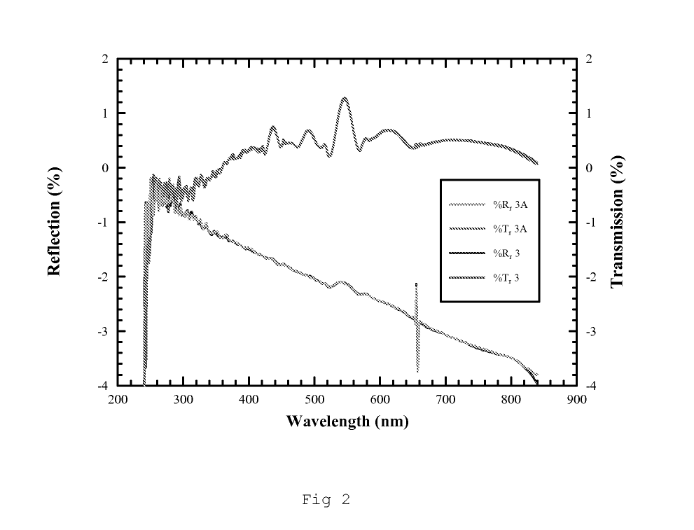

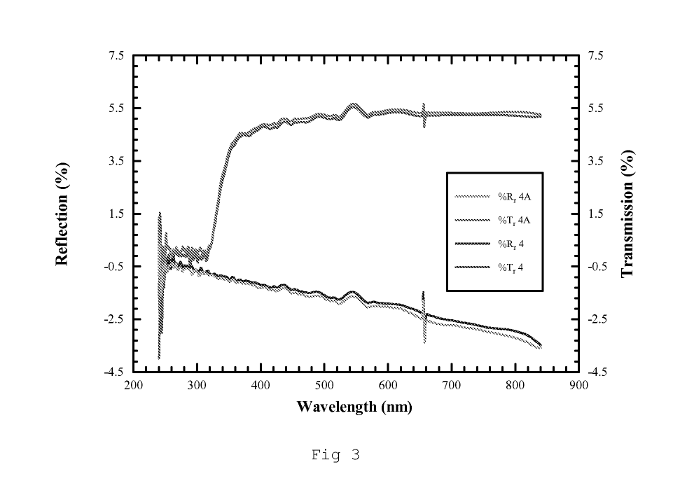

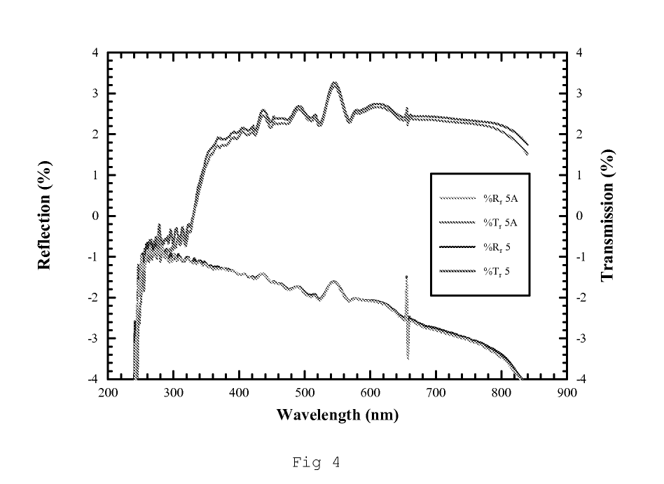

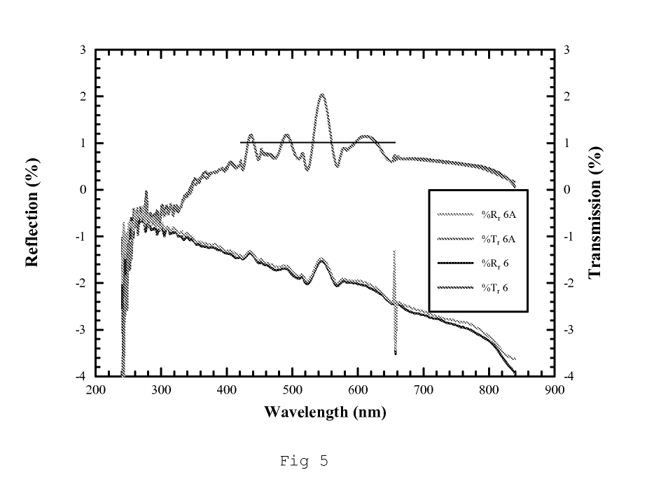

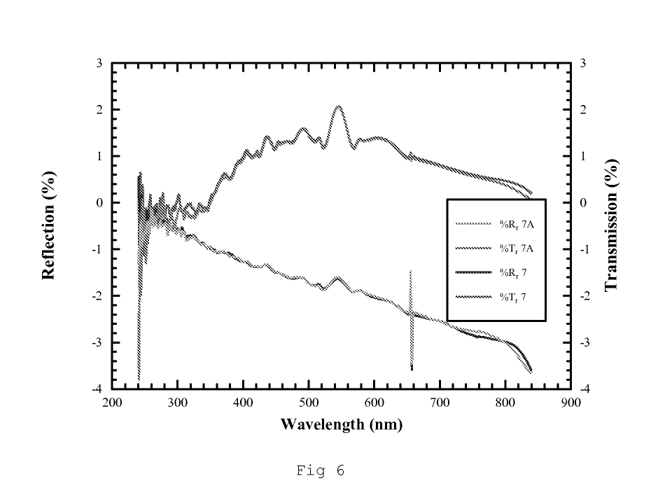

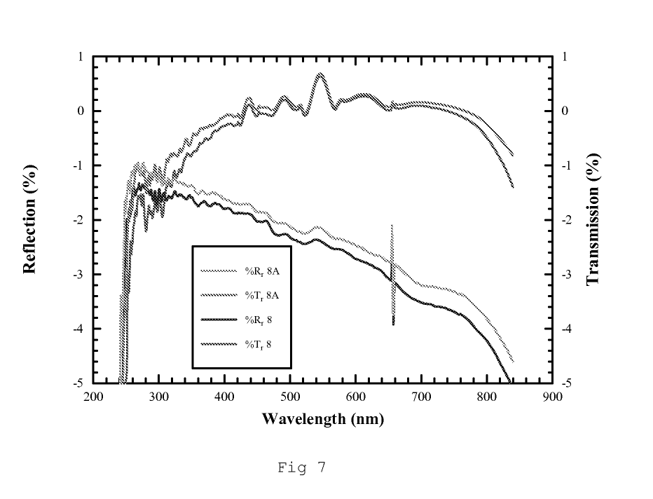

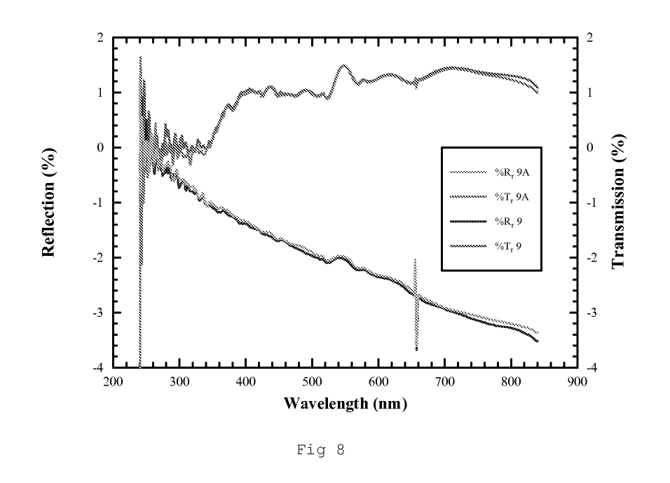

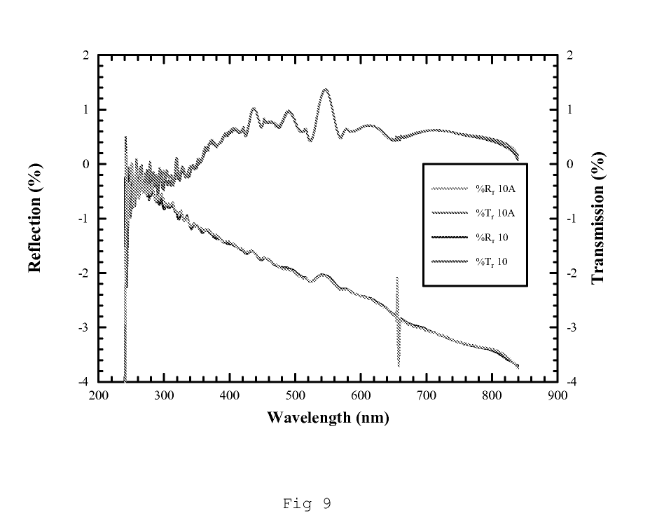

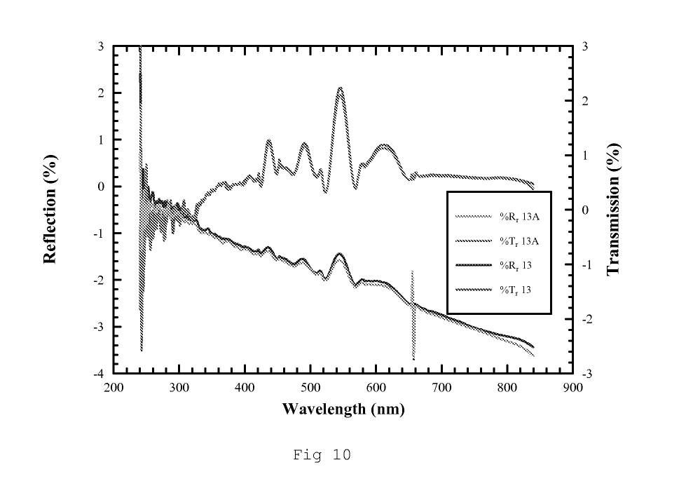

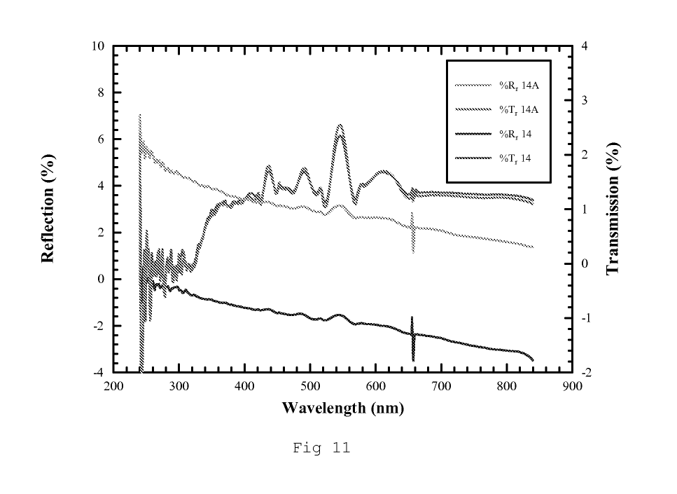

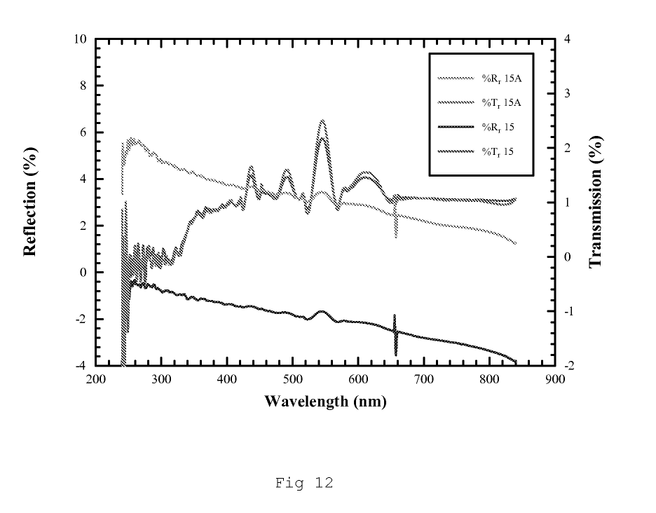

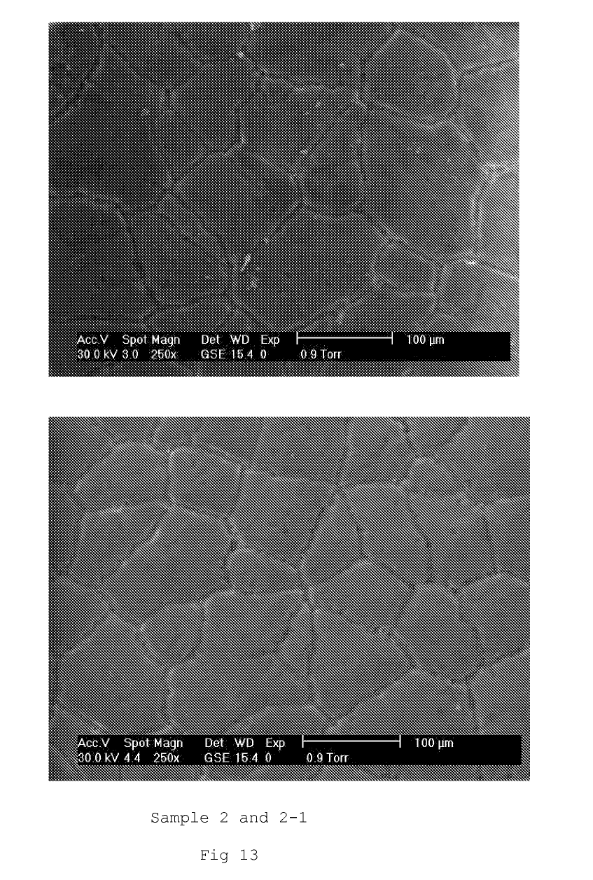

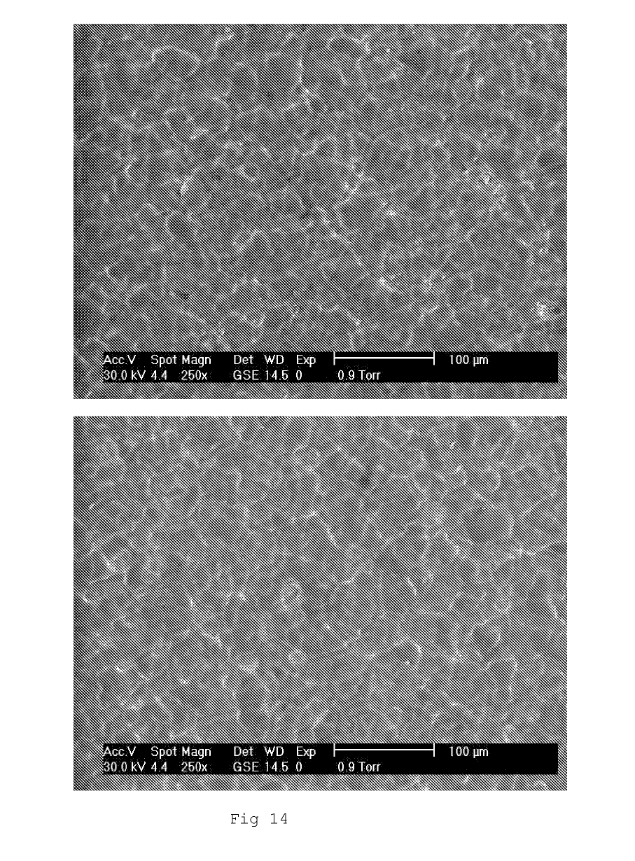

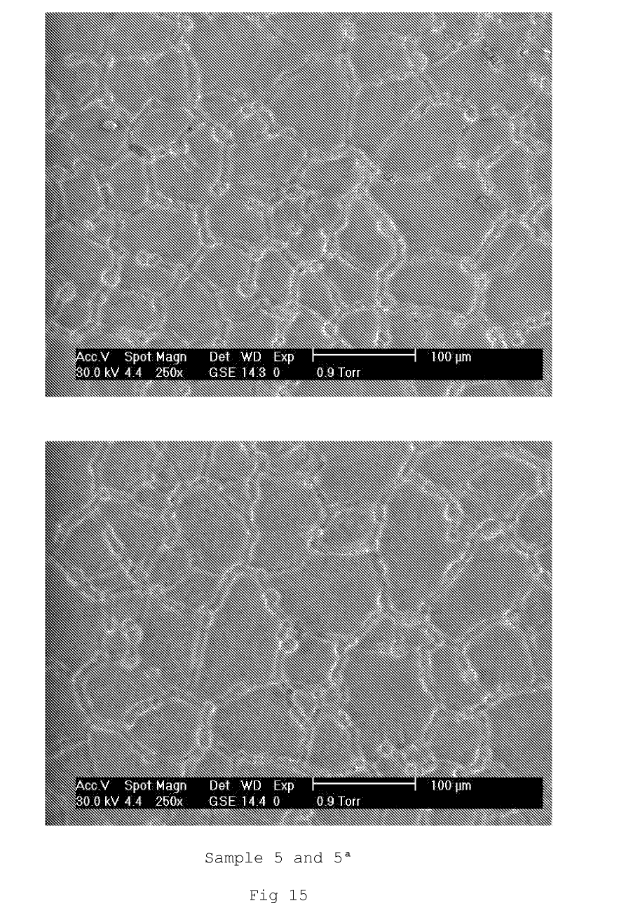

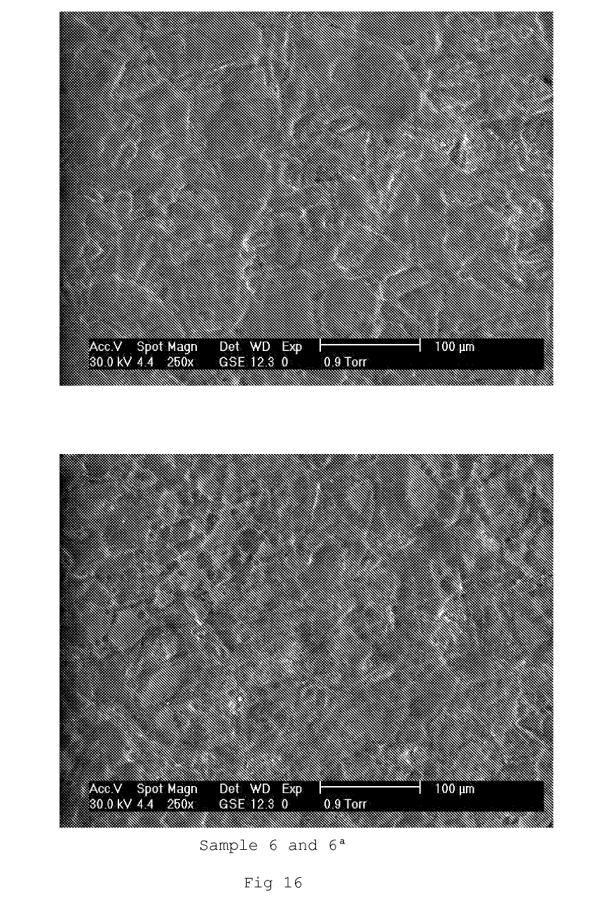

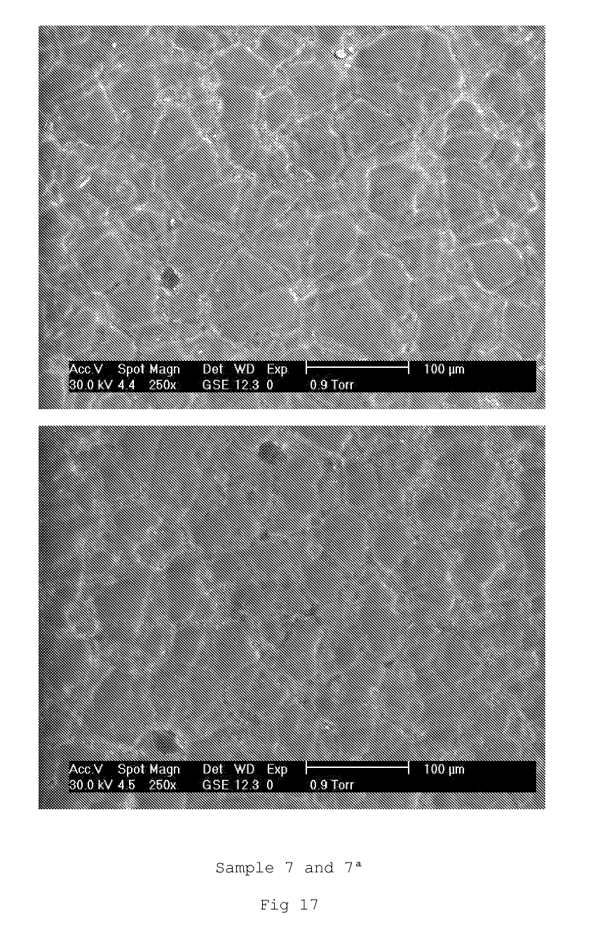

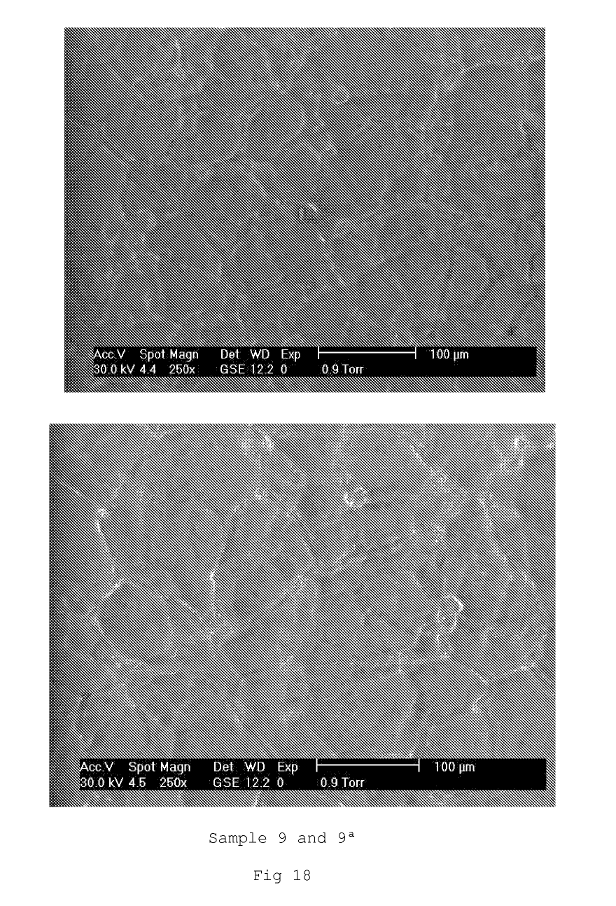

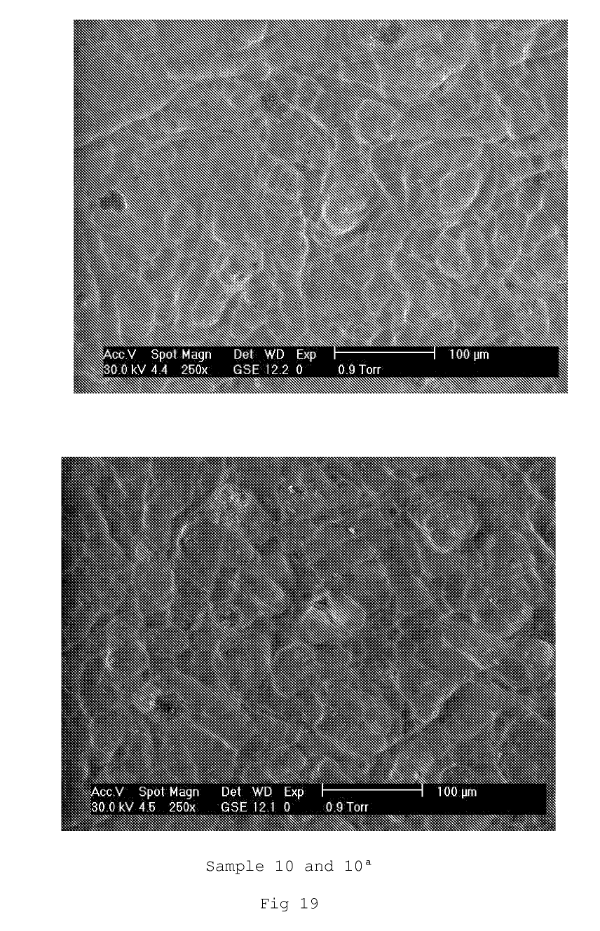

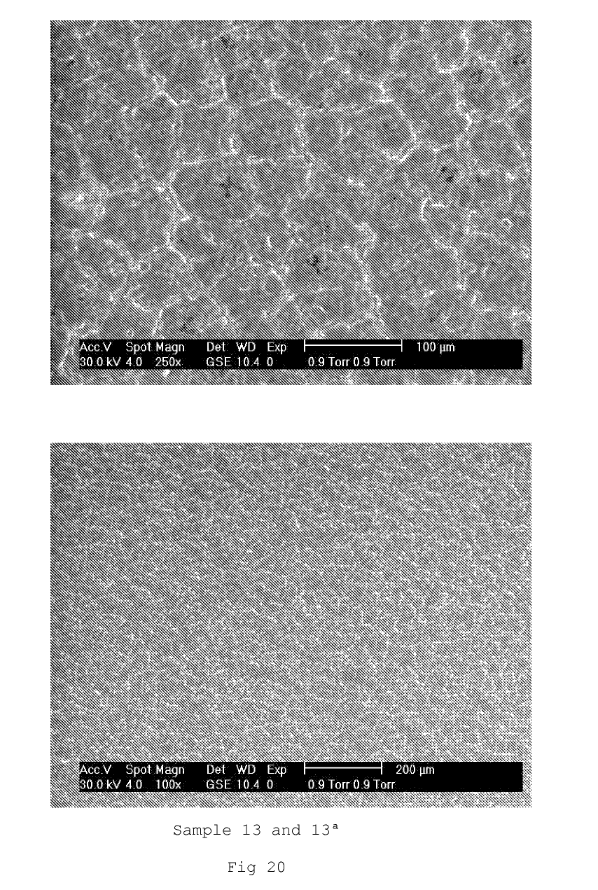

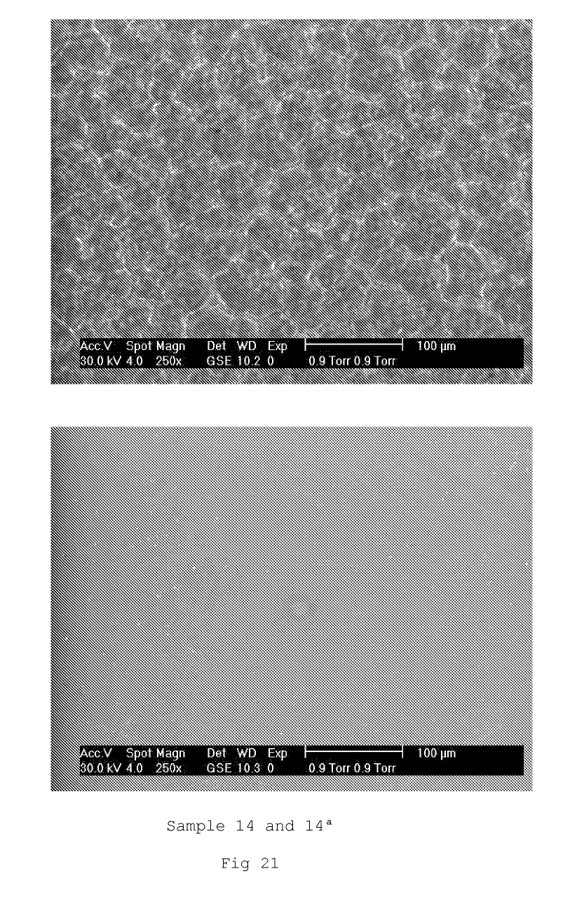

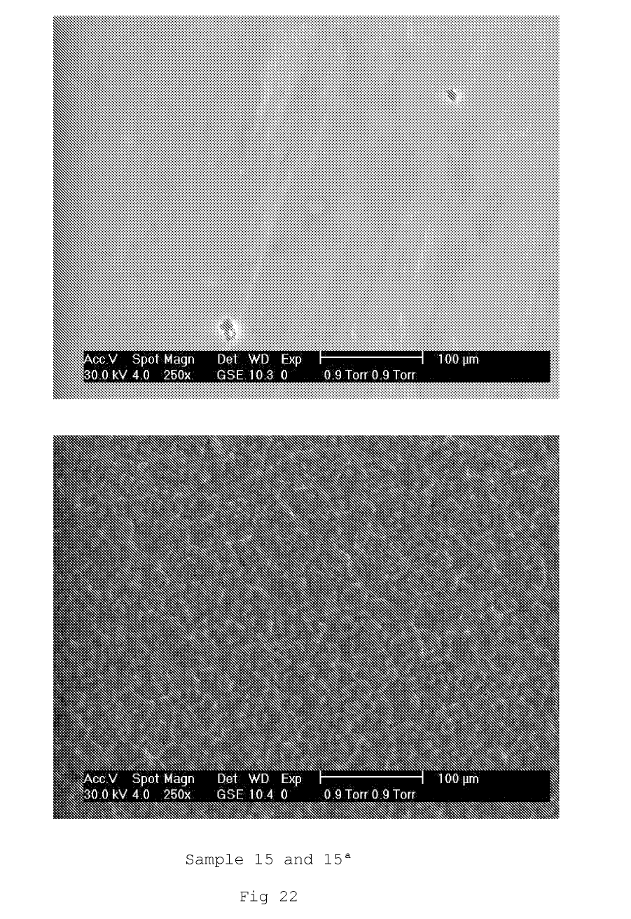

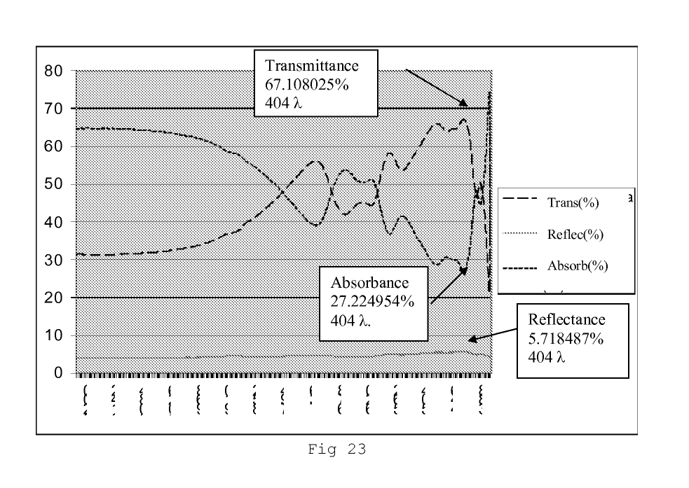

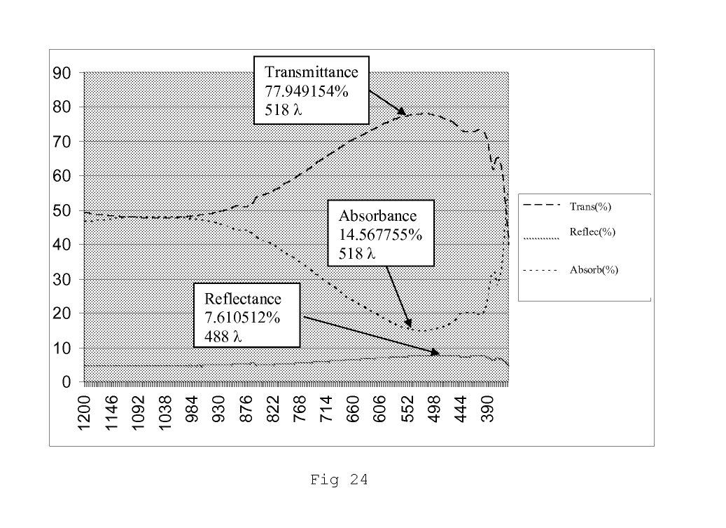

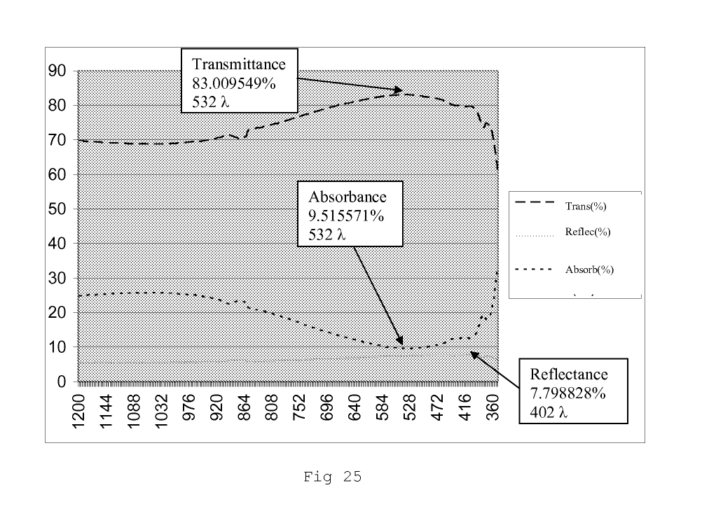

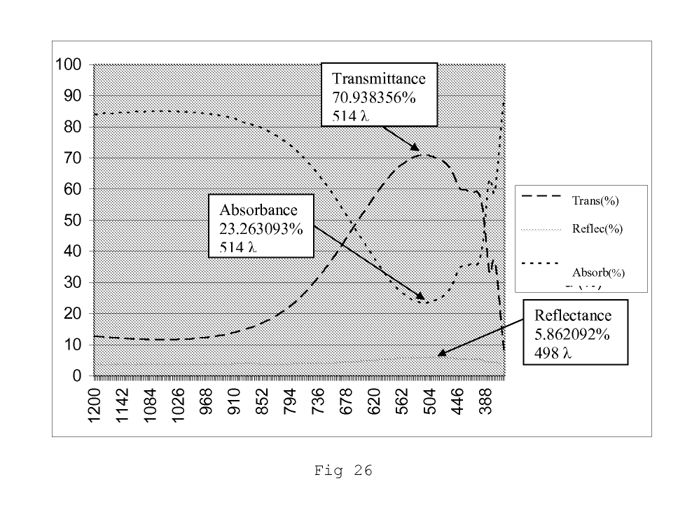

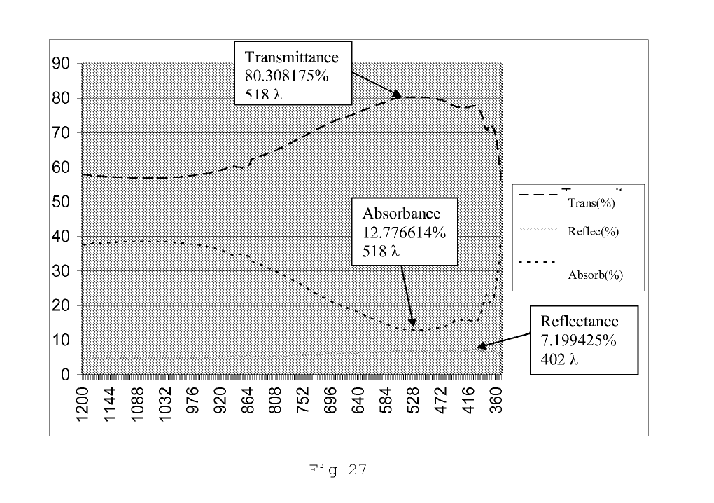

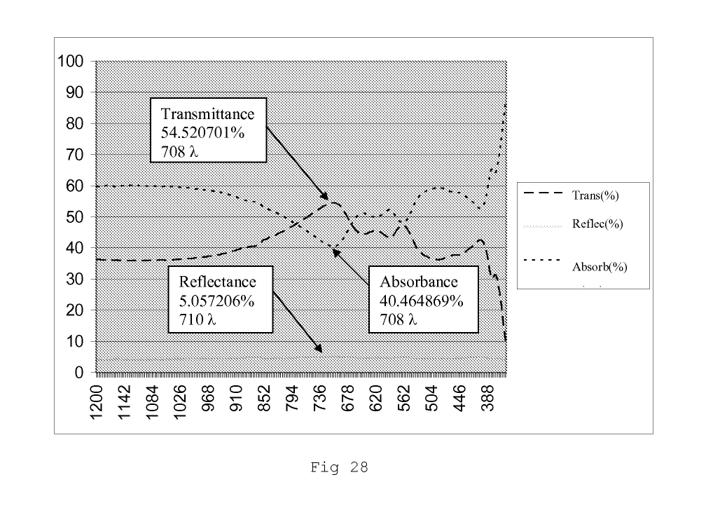

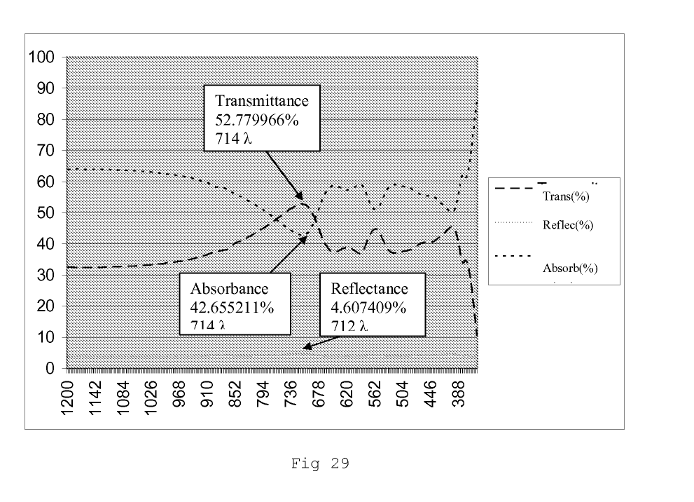

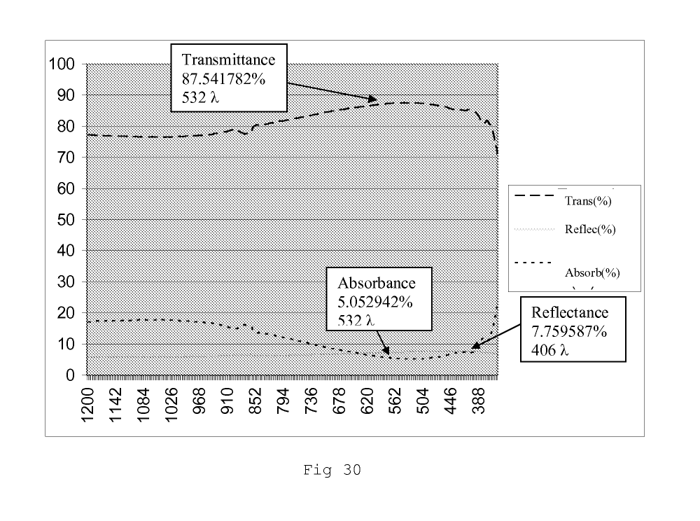

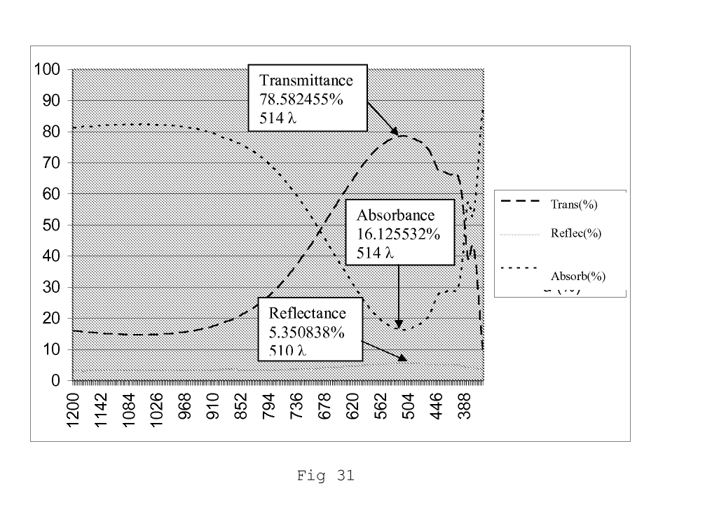

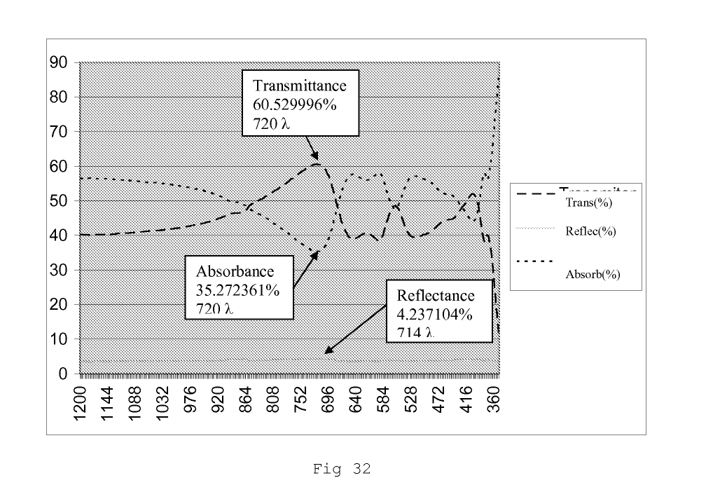

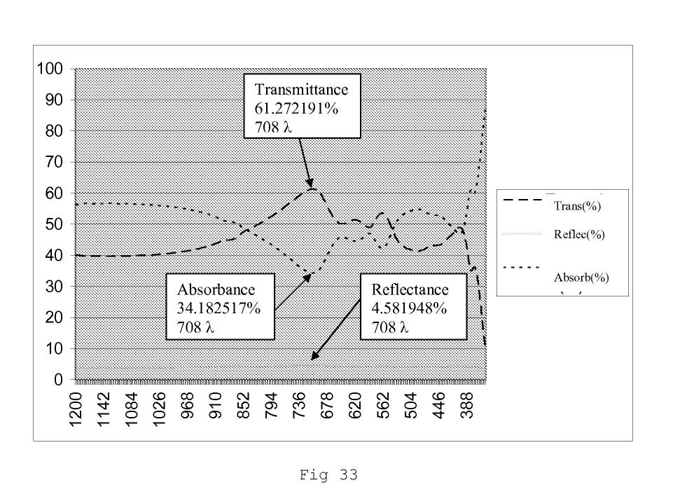

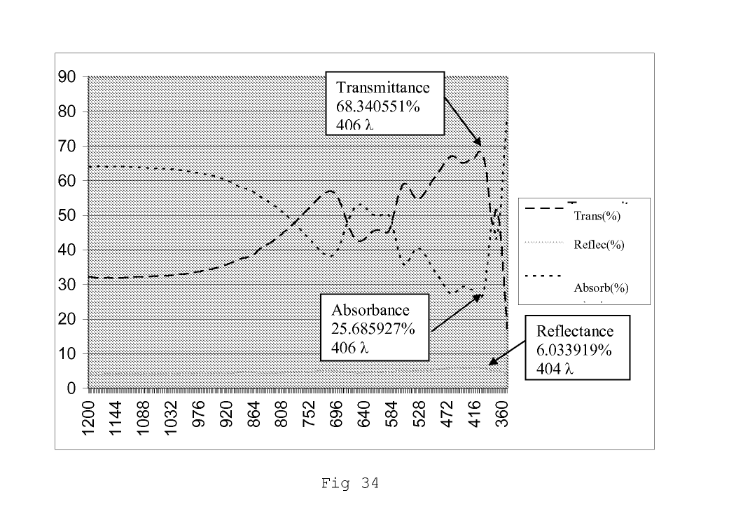

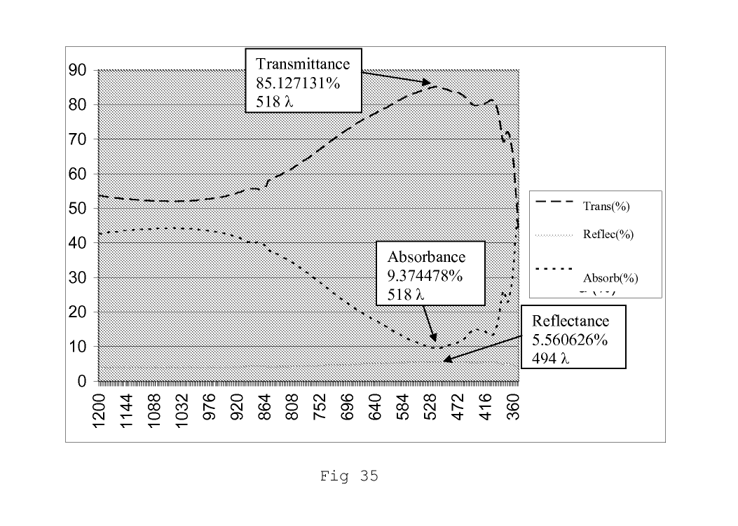

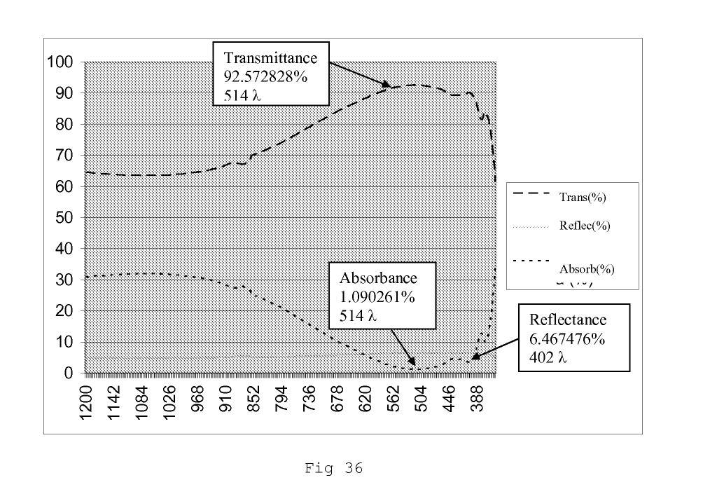

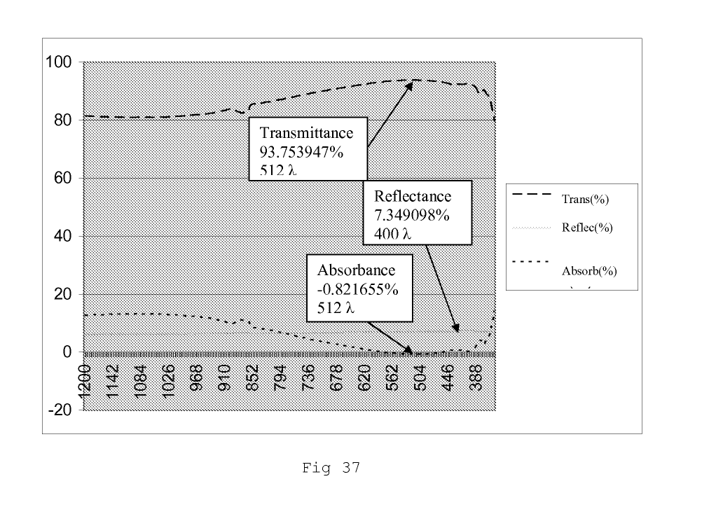

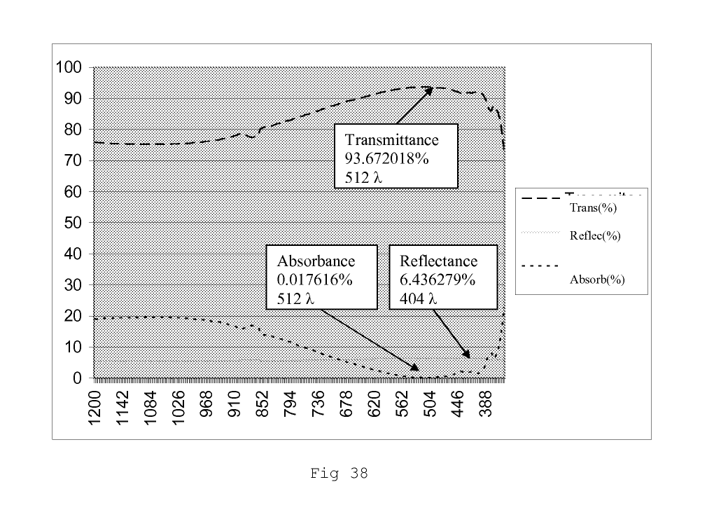

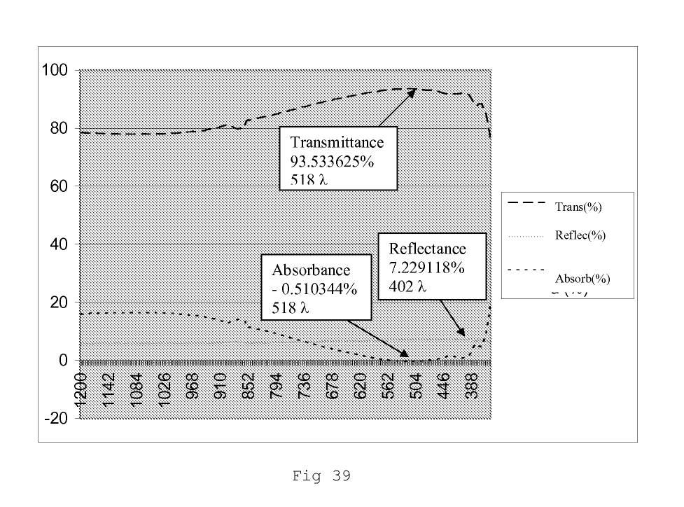

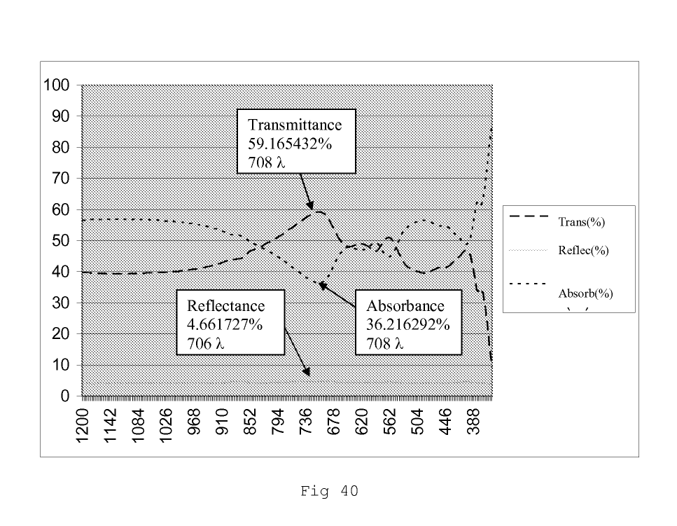

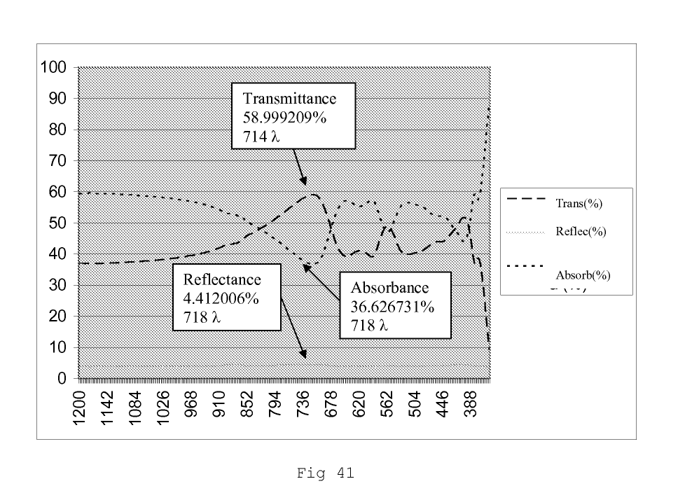

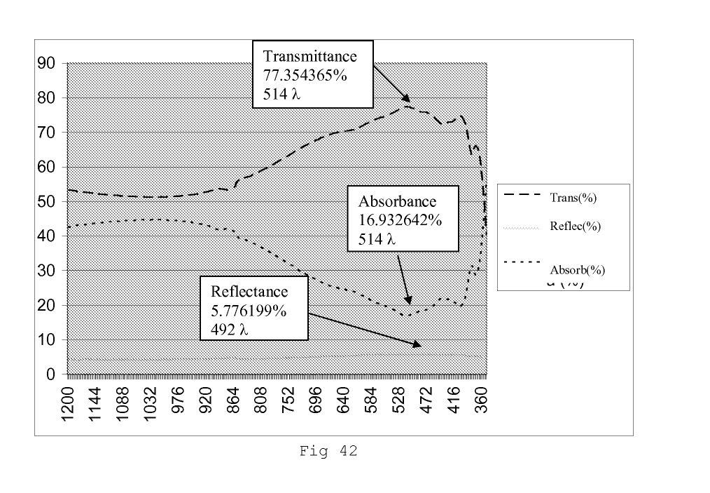

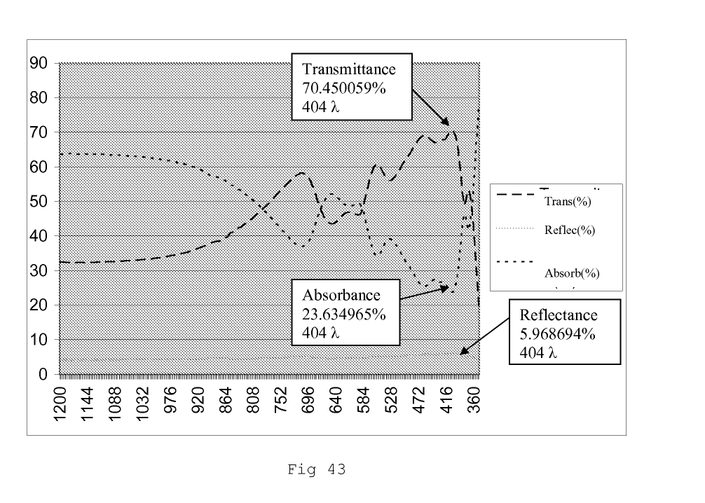

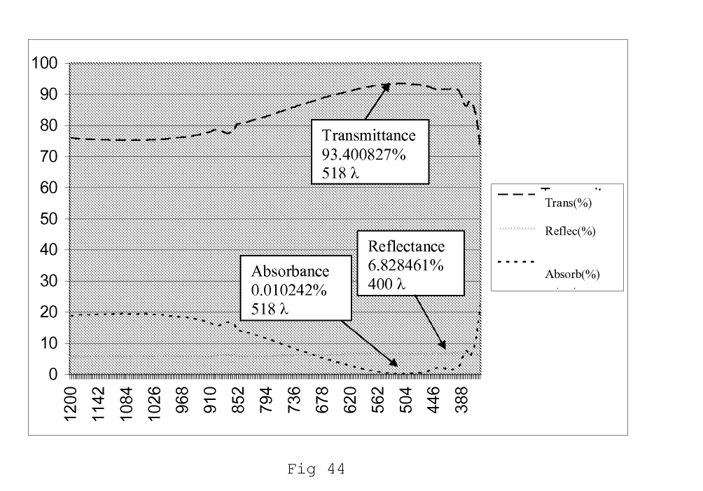

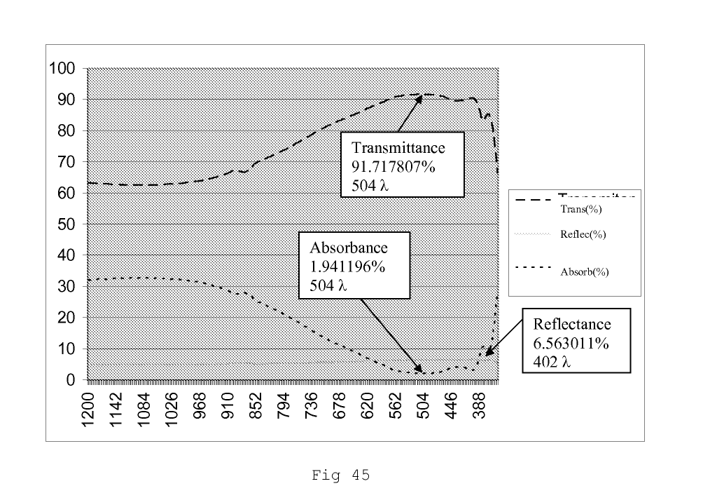

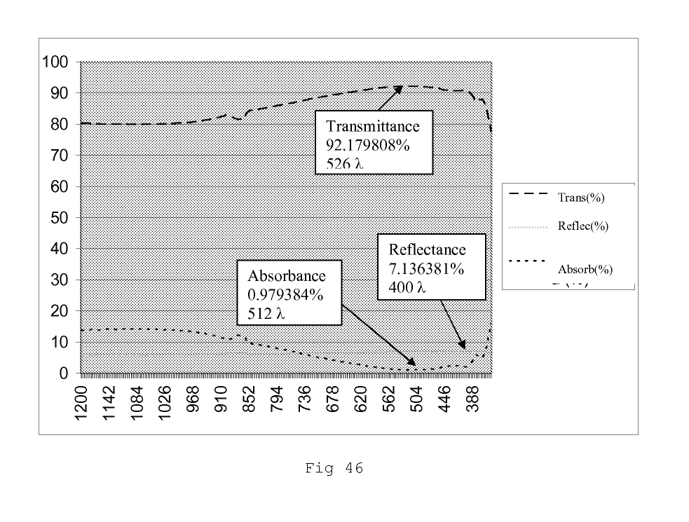

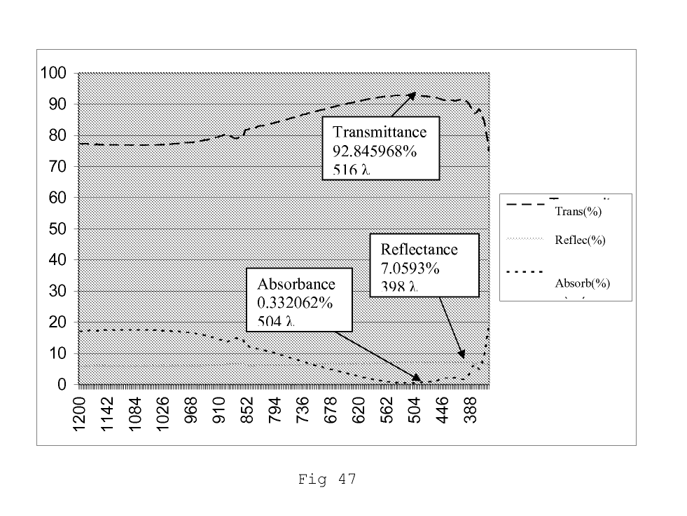

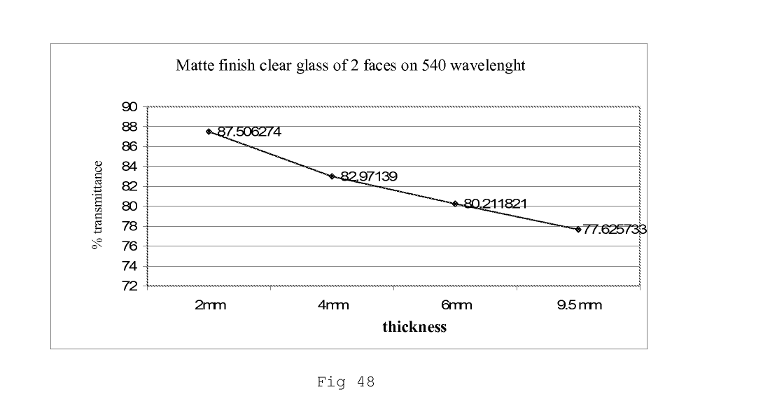

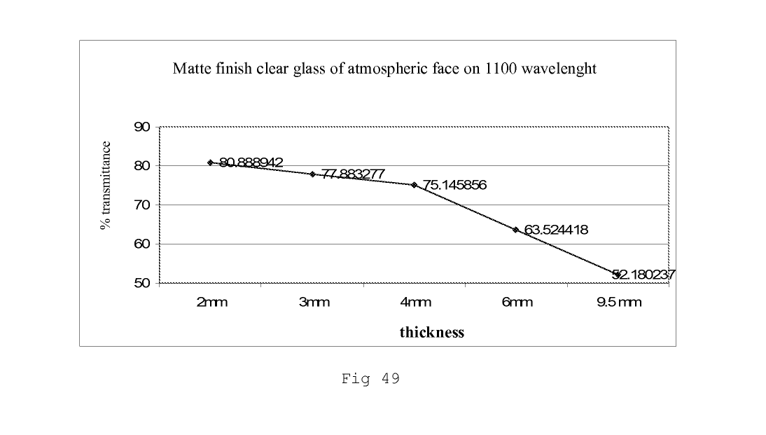

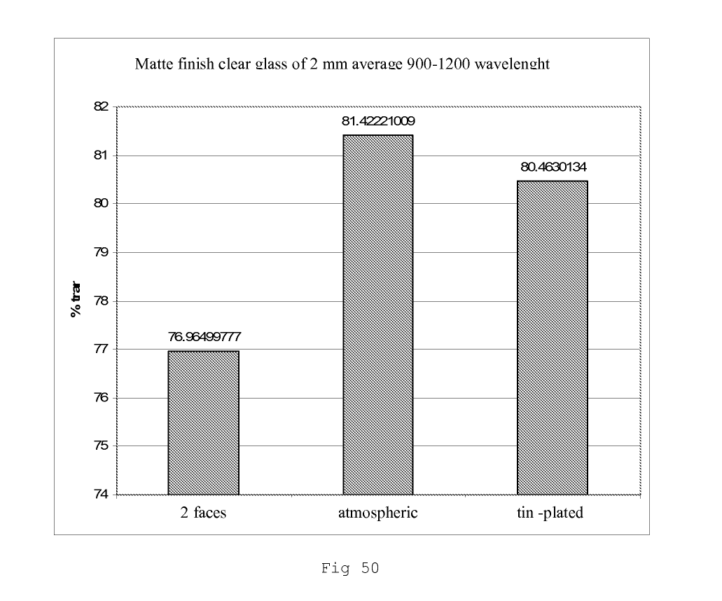

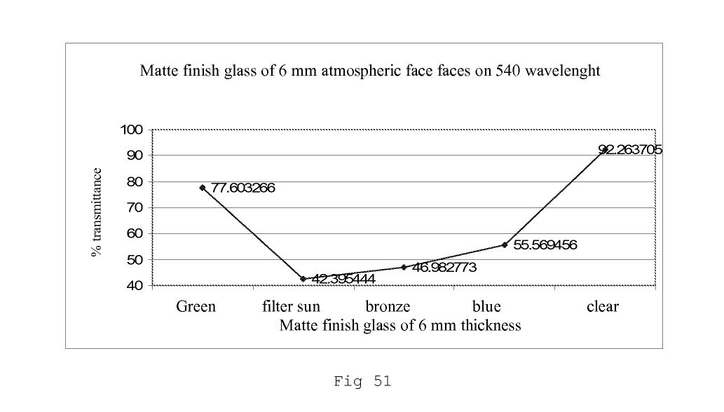

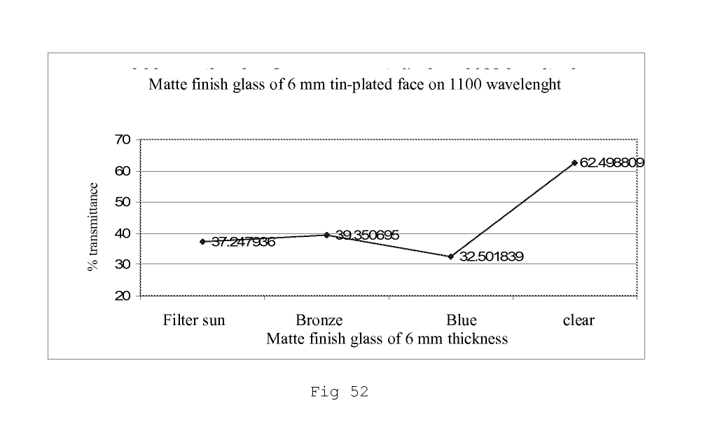

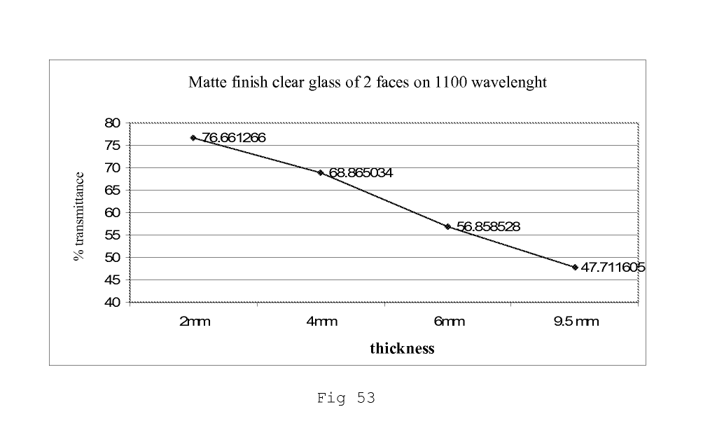

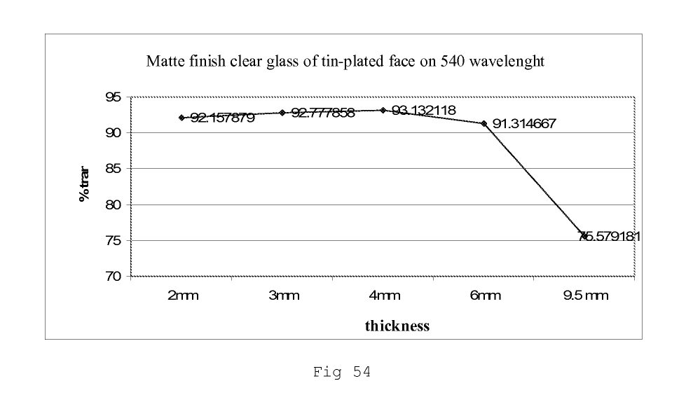

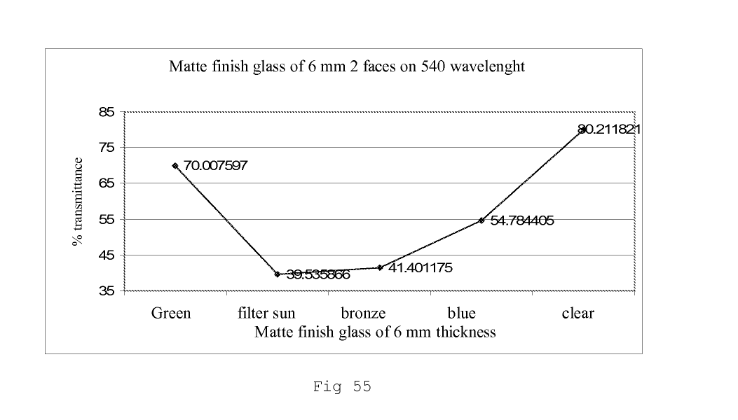

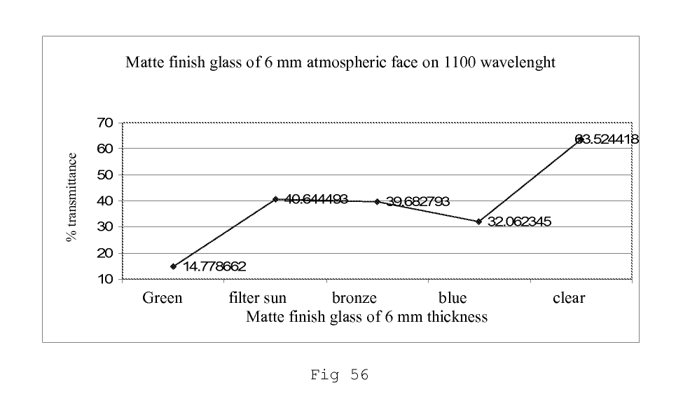

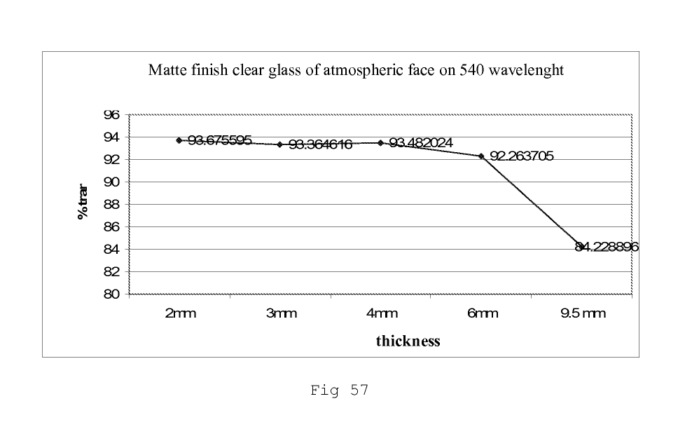

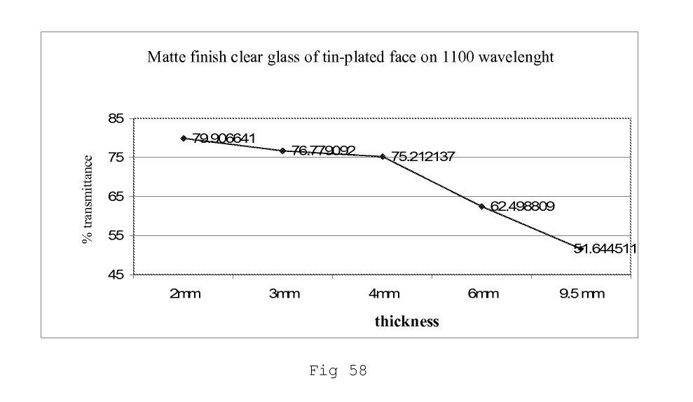

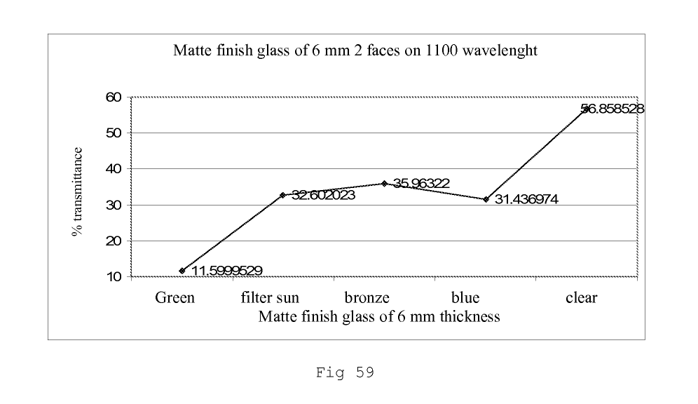

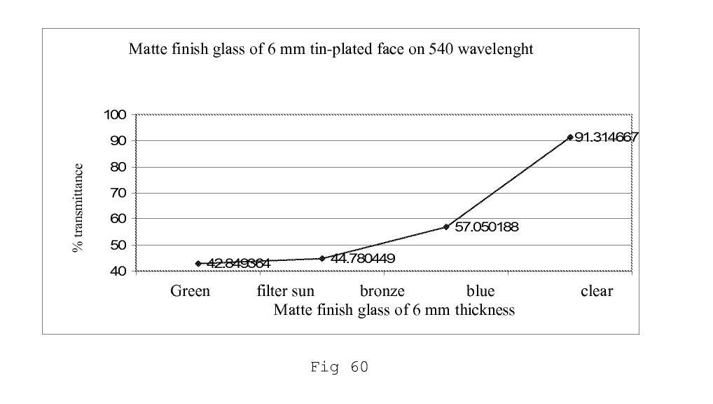

**SI = without identification
**SM = Satin-matte finish
**sample 2-1 = H in the FIG. 1

Roughness

Roughness measurements were performed with a TR 100 Surface Roughness Tester, mark TIME. Roughness parameters were Ra, average roughness and Rz, roughness average.

A measurement method

In each sample three measurements were performed (a, b and c) as follows:

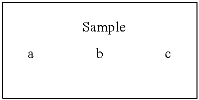

The Table 1 below shows the results of the roughness of the samples of satin-matte finish glass, Ra and Rz of the present invention (μM).

TABLE 1
Measures of Roughness in glasses: Ra and Rz

| Simple | Roughness (μM) | | | | | |
|---|---|---|---|---|---|---|
| # | Ra | | | Rz | | |
| 2-1 | 3.66 | 2.72 | 2.98 | 23.2 | 16.9 | 16.6 |
| 2 | 2.77 | 2.78 | 2.83 | 17.0 | 16.3 | 19.2 |
| 3 | 1.86 | 1.92 | 1.87 | 12.4 | 11.3 | 11.9 |
| 3A | 2.07 | 2.02 | 2.13 | 12.4 | 11.9 | 12.6 |
| 4 | 1.84 | 1.73 | 1.77 | 10.0 | 10.3 | 9.8 |
| 4A | 1.69 | 1.47 | 1.55 | 10.1 | 10.7 | 10.2 |
| 5 | 1.68 | 1.6 | 1.76 | 10.7 | 10.7 | 10.2 |
| 5A | 1.86 | 1.81 | 1.90 | 10.6 | 11.3 | 11.8 |
| 6 | 3.37 | 3.58 | 3.61 | 26.5 | 21.1 | 26.6 |
| 6A | 3.00 | 3.03 | 3.30 | 17.9 | 22.2 | 21.1 |
| 7 | 2.46 | 2.28 | 2.17 | 13.5 | 11.7 | 12.5 |
| 7A | 2.02 | 2.13 | 1.79 | 11.7 | 14.1 | 11.7 |
| 8 | 2.38 | 2.49 | 2.78 | 20.5 | 20.0 | 20.3 |
| 8A | 1.94 | 2.39 | 1.81 | 13.6 | 15.4 | 11.4 |
| 9 | 3.21 | 2.67 | 2.64 | 16.7 | 18.2 | 16.2 |
| 9A | 2.38 | 2.17 | 2.52 | 12.9 | 13.4 | 12.1 |
| 10 | 3.39 | 3.37 | 3.57 | 19.1 | 20.6 | 23.1 |
| 10A | 3.03 | 3.29 | 4.07 | 19.2 | 22.6 | 22.1 |
| 11 | SI | | | | | |
| 11A | SI | | | | | |
| 12 | SI | | | | | |
| 12A | SI | | | | | |
| 13 | 1.48 | 1.40 | 1.37 | 9.9 | 9.8 | 8.0 |
| 13A | 1.17 | 1.38 | 1.71 | 8.7 | 9.6 | 9.6 |
| 14 | 1.12 | 1.17 | 1.25 | 7.0 | 8.2 | 8.7 |
| 14A | 0.01 | 0.01 | 0.01 | ND | ND | ND |
| 15 | 1.04 | 1.22 | 1.20 | 6.7 | 8.7 | 8.3 |
| 15A | 0.01 | 0.01 | 0.01 | ND | ND | ND |

**ND = Not Detected, below the lower limit of measurement equipment
**SI = without identification

Measurement Method B

The larger sample was termed large glass and the other sample small glass; the faces were called A and B. Five measurements were taken on each side, in each sample.

Measurements were made along each of the samples, considering that this measurement falls in the middle of the sample, as follows:

The values obtained in each of the measurements were:

LARGE GLASS-ROUGHNESS (nm)

| No. Measurement | face A | face B |
|---|---|---|
| 1 | 1.87 | 1.81 |
| 2 | 1.82 | 1.60 |
| 3 | 1.68 | 1.61 |
| 4 | 2.00 | 1.77 |
| 5 | 2.12 | 1.79 |
| AVERAGE | 1.898 | 1.716 |

SMALL GLASS-ROUGHNESS (nm)

| No. Measurement | face A | face B1 |
|---|---|---|
| 1 | 1.68 | 1.64 |
| 2 | 1.79 | 1.82 |
| 3 | 1.47 | 1.95 |
| 4 | 1.51 | 1.73 |
| 5 | 1.68 | 1.77 |
| AVERAGE | 1.626 | 1.782 |

Transmission (Near Infrared)

Spectrophotometer was used with the Fourier Transform Infrared (FTIR) Perkin Elmer GX, measurements were made in the near infrared (NIR) on both faces and by the technique of transmission (% T).

The Table 2 below shows the results of transmission (Near Infrared) of samples of satin-matte finish glass

TABLE 2
Transmission (Near Infrared)

| | Wavelength | |
|---|---|---|
| Sample # | (cm⁻¹) | % T |
| 2 | 4213, 4704 | 14.8, 14.8 |
| 2-1 | 4203, 4689 | 14.8, 14.7 |
| 3 | 4131 | 6.9 |
| 3A | 4000 | 6.89 |
| 4 | 4167 | 35.6 |
| 4A | 4162 | 34.9 |
| 5 | 4192 | 19.5 |
| 5A | 4182 | 18.0 |
| 6 | 4192 | 7.8 |
| 6A | 4182 | 7.4 |
| 7 | 4131 | 8.6 |
| 7A | 4117 | 8.4 |
| 8 | 4132 | 4.5 |
| 8A | 4137 | 4.35 |
| 9 | 4157 | 14.9 |
| 9A | 4167 | 14.2 |
| 10 | 4157 | 7.1 |
| 10A | 4162 | 6.9 |
| 11 | SI | |
| 11A | SI | |
| 12 | SI | |
| 12A | SI | |
| 13 | 4000 | 8.5* |
| 13A | 4000 | 7.8* |
| 14 | 4000 | 13.8* |
| 14A | 4000 | 15.0 |
| 15 | 4000 | 14.0* |
| 15A | 4000 | 12.0* |

***it do not have a maximum transmission
***SI = without identification

Reflectance and Transmittance

The measurements were made at normal incidence in the spectral range of 240-840 nm (UV Vis) with the team FilmTek T 3000. The equipment was calibrated using as a maximum reflectance of silicon wafer polishing and the maximum transmittance of the air. The area that measures the team is the point of a millimeter of diameter.

The Table 3 below shows the measured reflectance and transmittance (542 nm) of the sample of satin-matte finish glass

3 Reflectance and transmittance (542 nm)

| Sample # | % T |
|---|---|
| 2 | 2.6 |
| 2-1 | |
| 3 | 1.3 |
| 3A | |
| 4 | 5.5 |
| 4A | |
| 5 | 3.4 |
| 5A | |
| 6 | 20 |
| 6A | |
| 7 | 2.0 |
| 7A | |
| 8 | 0.9 |
| 8A | |
| 9 | 1.9 |
| 9A | |
| 10 | 1.7 |
| 10A | |
| 11 | SI |
| 11A | |
| 12 | SI |
| 12A | |
| 13 | 2 |
| 13A | |
| 14 | 7.0 |
| 14A | |
| 15 | 6.4 |
| 15A | |

***The values are the same for both faces
***SI = without identification

Morphology

The measurements were made in a scanning electron microscope, the results are shown in the photographs of the sample 2-1 to 15, which shows a homogeneous morphology without staining, with a uniform roughness throughout the sample.

The following examples are intended to illustrate the invention, not limitation, any change by the experts in the art, fall within the scope of the present invention.

### EXAMPLES

Different satin-matte finish glasses are produced by one or both faces, in whole or in part, produced by the process described in MX Patent 258791, the resulting satin-matte finish glass, has a uniform perfectly homogeneous finish, a soft and smooth touch, with an appearance pleasing to the eye.

The chemical process for total satin-matte finish or partial, in one or both faces of float glass for the simultaneous production and continues for one or more parts and/or sheets by immersion in acid solution, comprising the following steps:

a) Receipt of the pieces and/or sheets of glass;
b) Load of the pieces and/or sheets of glass into containers;
c) Processing of the pieces and/or sheets of glass by immersion in the following stages:
i. Pre-treatment in a washing and cleaning solution.
ii. Immersion in an acid solution for satin-matte finish.
iii. Immersion in current water to rinse and then rinse by spraying with deionized water.
iv. Immersion in an acid solution to stop the reaction and ensure the satin-matte finished.
v. Immersion in current water to rinse and then rinse by spraying with deionized water.
vi. Immersion in deionized water for washing and then by spraying with deionized water.
vii. Immersion in deionized water for washing and then by spraying with deionized water.
viii. Immersion (optional) that is reserved for any eventuality;
d) Drying of the pieces and sheets of glass;
e) Download of the pieces and/or sheets of satin-matte finish glass from the container to stowage racks for storage, transport and distribution.

Stages of Immersion in the Following Solutions:

i)—Pre-treatment stage using a washing and cleaning solution composed of 55% deionized water at least 10 microhms, 5% hydrofluoric acid 70%, ie 3.5% acid and 1.5% water and 39.5% sugar dextrose monohydrate, to eliminate all foreign substances to the glass;
ii)—Immersion in an acid solution for satin-matte finish that contains 3 to 8% hydrofluoric acid at 70%, equivalent to 2.1% to 5.6% of total hydrofluoric acid, 3 to 8% hydrochloric acid at 30%, equivalent 0.9% to 2.4% total hydrochloric acid, 10 to 30% formic acid 85%, equivalent to 8.5% to 25.5% of the total formic acid, 20 to 40% of deionized water at least 10 microhms, 20 to 50% of anhydrous ammonium bifluoride and 5 to 25% sugar dextrose monohydrate, the speed of immersion is 5.2 meters / minute and the immersion time is from 5 minutes to 30 minutes.
iii)—Immersion to rinse and remove the remains of the previous acid solution, which is done by immersion in current water and then spraying with deionized water.
iv)—Immersion to stop the chemical reaction on the glass and remove all traces of the acid solution that may exist that contains 3 to 5% hydrochloric acid at 30%, equivalent to 0.9% to 1.5% of the total acid, 3 to 5% hydrofluoric acid at 70%, equivalent to 2.1% to 3.5% of hydrofluoric acid and water from 95 to 97%, this solution should be between 0.5 and 1.0 milliequivalents per liter, a pH of 2.1 to 3.2, the time immersion varies from 30 seconds to 3 minutes depending on the number of sheets of glass.
v)—Immersion rinse and remove the acid solution above, which is done by immersion in current water and then spraying with deionized water;
vi) and vii)—Stages of immersion to wash and remove the remains of the acid solution, which is done by immersion in deionized water and then by spraying deionized water; and
viii)—Immersion in case of any eventuality or necessity can be water or acid solution.

Drying of the pieces and/or sheets of glass is done in a drying chamber at a temperature of 30 to 60° C., or can also be done to the environment temperature, or through a washer/dryer vertically or horizontally, or through a tunnel furnace operated with natural gas, LP gas and/or electrical resistance, without affecting the quality of the glass.

### Example 1

The obtained satin-matte finish glass has the following properties:

Blue satin-matte finish glass of 6-mm 2 faces

| Wavelength | Transmittance | Absorbance | Reflectance |
|---|---|---|---|
| λ | (%) | (%) | (%) |
| 1200 | 31.372934 | 64.660095 | 3.998963 |
| 768 | 49.049349 | 46.457290 | 4.529598 |
| 404 | 67.108025 | 27.224954 | 5.718487 |
| 402 | 66.898015 | 27.438183 | 5.715239 |
| 352 | 21.331969 | 74.321201 | 4.41751 |

These values are described in the corresponding graphs that are observed in the respective curves of each type of satin-matte finish glass of the present invention.

### Example 2

Clear satin-matte finish glass of 9.5 mm by 2 faces

| Wavelength | Transmittance | Absorbance | Reflectance |
|---|---|---|---|
| λ | (%) | (%) | (%) |
| 1200 | 49.033639 | 46.582841 | 4.418871 |
| 768 | 60.069419 | 34.629035 | 5.3443 |
| 518 | 77.949154 | 14.567755 | 7.55105 |
| 488 | 77.028676 | 15.429307 | 7.610512 |
| 352 | 44.122508 | 50.707328 | 5.254232 |

### Example 3

Clear satin-matte finish glass of 4 mm by 2 faces

| Wavelength | Transmittance | Absorbance | Reflectance |
|---|---|---|---|
| λ | (%) | (%) | (%) |
| 1200 | 69.714506 | 24.864735 | 5.464475 |
| 768 | 76.001305 | 17.803862 | 6.244791 |
| 532 | 83.009549 | 9.515571 | 7.542765 |
| 402 | 79.54126 | 12.730101 | 7.798828 |
| 352 | 63.041881 | 30.818024 | 6.239934 |

### Example 4

Green satin-matte finish glass of 6 mm by 2 faces

| Wavelength | Transmittance | Absorbance | Reflectance |
|---|---|---|---|
| λ | (%) | (%) | (%) |
| 1200 | 12.56139 | 83.935142 | 3.531722 |
| 768 | 25.891355 | 70.393580 | 3.745025 |
| 514 | 70.938356 | 23.263093 | 5.851212 |
| 498 | 70.268567 | 23.922100 | 5.862092 |
| 352 | 9.485169 | 86.752984 | 3.823015 |

### Example 5

Clear satin-matte finish glass of 6 mm by 2 faces

| Wavelength | Transmittance | Absorbance | Reflectance |
|---|---|---|---|
| λ | (%) | (%) | (%) |
| 1200 | 57.768439 | 37.600626 | 4.668281 |
| 768 | 67.624158 | 26.916992 | 5.502873 |
| 518 | 80.308175 | 12.776613 | 6.978014 |
| 402 | 77.548383 | 15.316987 | 7.199425 |
| 352 | 58.741911 | 35.537383 | 5.813726 |

### Example 6

Bronze satin-matte finish glass of 6 mm by 2 faces

| Wavelength | Transmittance | Absorbance | Reflectance |
|---|---|---|---|
| λ | (%) | (%) | (%) |
| 1200 | 36.241169 | 59.754976 | 4.036144 |
| 710 | 54.432016 | 40.551236 | 5.057206 |
| 708 | 54.520701 | 40.464869 | 5.054869 |
| 402 | 42.462812 | 52.718585 | 4.862364 |
| 352 | 10.905156 | 85.047813 | 4.112836 |

### Example 7

Filtrasol satin-matte finish glass of 6 mm by 2 faces

| Wavelength | Transmittance | Absorbance | Reflectance |
|---|---|---|---|
| λ | (%) | (%) | (%) |
| 1200 | 32.405953 | 63.924501 | 3.699139 |
| 714 | 52.779966 | 42.655211 | 4.601636 |
| 712 | 52.755428 | 42.674022 | 4.607409 |
| 402 | 45.380058 | 50.082564 | 4.578585 |
| 352 | 13.050861 | 83.232472 | 3.777101 |

### Example 8

Clear satin-matte finish glass of 2 mm by 2 faces

| Wavelength | Transmittance | Absorbance | Reflectance |
|---|---|---|---|
| λ | (%) | (%) | (%) |
| 1200 | 77.235 | 17.115996 | 5.69456 |
| 714 | 84.195213 | 9.212696 | 6.645253 |
| 532 | 87.541782 | 5.052942 | 7.472529 |
| 406 | 85.198044 | 7.112205 | 7.759587 |
| 352 | 73.081519 | 6.652967 | 20.371961 |

### Example 9

Green satin-matte finish glass of 6 mm by atmospheric face

| Wavelength | Transmittance | Absorbance | Reflectance |
|---|---|---|---|
| λ | (%) | (%) | (%) |
| 1200 | 15.853307 | 81.198414 | 2.972055 |
| 714 | 41.918366 | 54.482090 | 3.628573 |
| 514 | 78.582455 | 16.125532 | 5.340074 |
| 510 | 78.475325 | 16.221995 | 5.350838 |
| 352 | 12.446269 | 84.077958 | 3.53229 |

### Example 10

Filtrasol satin-matte finish glass of 6 mm atmospheric face

| Wavelength | Transmittance | Absorbance | Reflectance |
|---|---|---|---|
| λ | (%) | (%) | (%) |
| 1200 | 40.075193 | 56.553311 | 3.398685 |
| 720 | 60.529996 | 35.272361 | 4.231495 |
| 714 | 60.470018 | 35.326775 | 4.237104 |
| 510 | 39.608186 | 56.786257 | 3.638302 |
| 352 | 14.225484 | 82.316789 | 3.51395 |

### Example 11

Bronze satin-matte finish glass of 6 mm atmospheric face

| Wavelength | Transmittance | Absorbance | Reflectance |
|---|---|---|---|
| λ | (%) | (%) | (%) |
| 1200 | 39.945943 | 56.399722 | 3.683805 |
| 720 | 60.692286 | 34.793814 | 4.550302 |
| 708 | 61.272191 | 34.182517 | 4.581948 |
| 510 | 41.941549 | 54.073823 | 4.020815 |
| 352 | 12.36567 | 83.963287 | 3.730735 |

### Example 12

Blue satin-matte finish glass of 6 mm atmospheric face

| Wavelength | Transmittance | Absorbance | Reflectance |
|---|---|---|---|
| λ | (%) | (%) | (%) |
| 1200 | 32.03812 | 64.027554 | 3.966054 |
| 720 | 56.288231 | 38.729629 | 5.022319 |
| 406 | 68.340551 | 25.685927 | 6.027772 |
| 404 | 68.32067 | 25.699716 | 6.033919 |
| 352 | 21.518846 | 74.152498 | 4.399041 |

### Example 13

Clear satin-matte finish glass of 9.5 mm atmospheric face

| Wavelength | Transmittance | Absorbance | Reflectance |
|---|---|---|---|
| λ | (%) | (%) | (%) |
| 1200 | 53.565179 | 42.694079 | 3.770909 |
| 720 | 70.404165 | 24.997802 | 4.635114 |
| 518 | 85.127131 | 9.374478 | 5.548326 |
| 494 | 84.253143 | 10.236277 | 5.560626 |
| 352 | 48.675493 | 47.225053 | 4.166112 |

### Example 14

Clear satin-matte finish glass of 6 mm atmospheric face

| Wavelength | Transmittance | Absorbance | Reflectance |
|---|---|---|---|
| λ | (%) | (%) | (%) |
| 1200 | 64.452909 | 30.967417 | 4.616607 |
| 720 | 80.431063 | 14.084781 | 5.528383 |
| 514 | 92.572828 | 1.090261 | 6.394461 |
| 402 | 90.087047 | 3.503684 | 6.467476 |
| 352 | 65.538125 | 29.421212 | 5.122625 |

### Example 15

Clear satin-matte finish glass of 2 mm atmospheric face

| Wavelength | Transmittance | Absorbance | Reflectance |
|---|---|---|---|
| λ | (%) | (%) | (%) |
| 1200 | 81.296597 | 12.707311 | 6.044448 |
| 720 | 89.423691 | 4.040366 | 6.588652 |
| 512 | 93.753947 | −0.821655 | 7.131895 |
| 400 | 92.367767 | 0.349277 | 7.349098 |
| 352 | 81.526225 | 11.962840 | 6.616804 |

### Example 16

Clear satin-matte finish glass of 4 mm atmospheric face

| Wavelength | Transmittance | Absorbance | Reflectance |
|---|---|---|---|
| λ | (%) | (%) | (%) |
| 1200 | 75.732739 | 19.031403 | 5.278083 |
| 720 | 86.848305 | 7.322774 | 5.875928 |
| 512 | 93.672018 | 0.017616 | 6.367675 |
| 404 | 92.106548 | 1.515100 | 6.436279 |
| 352 | 74.666725 | 19.907474 | 5.514025 |

### Example 17

Clear satin-matte finish glass of 3 mm atmospheric face

| Wavelength | Transmittance | Absorbance | Reflectance |
|---|---|---|---|
| λ | (%) | (%) | (%) |
| 1200 | 78.395095 | 15.979032 | 5.671243 |
| 720 | 87.940732 | 5.718345 | 6.392059 |
| 518 | 93.533625 | −0.510344 | 7.04008 |
| 402 | 92.067313 | 0.768631 | 7.229118 |
| 352 | 78.073423 | 15.733678 | 6.293597 |

### Example 18

Bronze satin-matte finish glass of 6 mm stained face

| Wavelength | Transmittance | Absorbance | Reflectance |
|---|---|---|---|
| λ | (%) | (%) | (%) |
| 1200 | 39.667245 | 56.529638 | 3.833787 |
| 708 | 59.165432 | 36.216292 | 4.65552 |
| 706 | 59.13625 | 36.239317 | 4.661727 |
| 402 | 46.847755 | 48.729100 | 4.463315 |
| 352 | 11.883955 | 84.367479 | 3.809518 |

### Example 19

Filtrasol satin-matte finish glass of 6 mm stained face

| Wavelength | Transmittance | Absorbance | Reflectance |
|---|---|---|---|
| λ | (%) | (%) | (%) |
| 1200 | 36.912386 | 59.446477 | 3.670501 |
| 718 | 58.996559 | 36.626731 | 4.412006 |
| 714 | 58.999209 | 36.627326 | 4.408735 |
| 402 | 51.688854 | 44.004914 | 4.34534 |
| 352 | 12.032379 | 84.410448 | 3.615013 |

### Example 20

Clear satin-matte finish glass of 9.5 mm stained face

| Wavelength | Transmittance | Absorbance | Reflectance |
|---|---|---|---|
| λ | (%) | (%) | (%) |
| 1200 | 53.275541 | 42.677956 | 4.079136 |
| 718 | 66.075308 | 29.057387 | 4.906557 |
| 514 | 77.354365 | 16.932642 | 5.764877 |
| 492 | 76.488955 | 17.786832 | 5.776199 |
| 352 | 44.967471 | 50.617009 | 4.487317 |

### Example 21

Blue satin-matte finish glass of 6 mm stained face

| Wavelength | Transmittance | Absorbance | Reflectance |
|---|---|---|---|
| λ | (%) | (%) | (%) |
| 1200 | 32.359597 | 63.655372 | 4.017168 |
| 718 | 57.727465 | 37.303283 | 5.009327 |
| 514 | 58.533978 | 36.380409 | 5.131799 |
| 404 | 70.450059 | 23.634965 | 5.968694 |
| 352 | 22.39208 | 73.343824 | 4.333431 |

### Example 22

Clear satin-matte finish glass of 4 mm stained face

| Longitud | | | |
|---|---|---|---|
| de onda | Transmitancia | Absorbancia | Reflactancia |
| λ | (%) | (%) | (%) |
| 1200 | 75.79831 | 18.813924 | 5.431216 |
| 718 | 86.706381 | 7.278846 | 6.063279 |
| 518 | 93.400827 | 0.010242 | 6.64877 |
| 400 | 91.773133 | 1.459862 | 6.828461 |
| 352 | 75.196424 | 18.960358 | 5.93823 |

### Example 23

Clear satin-matte finish glass of 6 mm stained face

| Wavelength | Transmittance | Absorbance | Reflectance |
|---|---|---|---|
| λ | (%) | (%) | (%) |
| 1200 | 63.23887 | 31.994332 | 4.80524 |
| 718 | 80.244873 | 14.204235 | 5.595657 |
| 504 | 91.717807 | 1.941196 | 6.398584 |
| 402 | 90.511234 | 2.984822 | 6.563011 |
| 352 | 69.612697 | 24.929985 | 5.546055 |

### Example 24

Clear satin-matte finish glass of 2 mm stained face

| Wavelength | Transmittance | Absorbance | Reflectance |
|---|---|---|---|
| λ | (%) | (%) | (%) |
| 1200 | 80.36294 | 13.741684 | 5.942919 |
| 526 | 92.179808 | 1.002246 | 6.879865 |
| 512 | 92.168489 | 0.979384 | 6.914356 |
| 400 | 90.813101 | 2.114745 | 7.136381 |
| 352 | 79.587209 | 13.981666 | 6.535696 |

### Example 25

Clear satin-matte finish glass of 3 mm stained face

| Wavelength | Transmittance | Absorbance | Reflectance |
|---|---|---|---|
| λ | (%) | (%) | (%) |
| 1200 | 77.276597 | 16.981463 | 5.788246 |
| 516 | 92.845968 | 0.348715 | 6.867121 |
| 504 | 92.830179 | 0.332062 | 6.899858 |
| 398 | 91.098645 | 1.955004 | 7.0593 |
| 352 | 77.159543 | 16.574801 | 6.367537 |

The satin-matte finish glass for one or both faces, in whole or in part, with a uniform finished perfectly homogeneous, a soft and smooth touch with a pleasant view of the present invention comprises the following properties and characteristics
A roughness Ra of 1.04 to 4.07 and a roughness Rz of 6.7 to 23.2 and
A (%) of transmittance, a (%) Absorbance and (%) Reflectance following:

| Wavelength | Transmittance | Absorbance | Reflectance |
|---|---|---|---|
| λ | (%) | (%) | (%) |
| 1200 | 12.56139 to | 12.707311 to | 2.972055 to |
| | 81.296597 | 83.935142 | 6.044448 |
| 768 | 25.891355 to | 5.709674 to | 3.346444 to |
| | 87.898596 | 70.393580 | 6.443276 |
| 720 | 34.61519 to | 4.040366 to | 3.960891 to |
| | 89.423691 | 61.455606 | 7.322774 |
| 718 | 35.025276 to | 3.953403 to | 3.600169 to |
| | 89.518513 | 55.434943 | 6.629092 |
| 714 | 89.699694 to | 60.182441 to | 6.645253 to |
| | 35.850942 | 3.741442 | 3.628573 |
| 712 | 89.694905 to | 59.762148 to | 6.614862 to |
| | 36.257736 | 3.743152 | 3.644698 |
| 710 | 89.747533 to | 59.350244 to | 6.667825 to |
| | 42.803583 | 3.688802 | 4.027526 |
| 708 | 89.893135 to | 58.904344 to | 6.659311 to |
| | 37.088171 | 3.546284 | 3.671819 |
| 706 | 89.920716 to | 58.474767 to | 6.675685 to |
| | 37.499234 | 3.497781 | 3.687479 |
| 532 | 93.746683 to | 58.259737 to | 7.542765 to |
| | 37.70885 | −0.767606 | 3.639551 |
| 526 | 93.662159 to | 58.847215 to | 7.565384 to |
| | 37.141857 | −0.692053 | 3.625793 |
| 518 | 93.716698 to | 58.957378 to | 7.5887 to |
| | 37.033218 | −0.776725 | 3.629727 |
| 516 | 93.652153 to | 58.961731 to | 7.596881 to |
| | 37.027553 | −0.713193 | 3.628661 |
| 514 | 93.717187 to | 58.910981 to | 7.604888 to |
| | 37.075171 | −0.780230 | 3.634535 |
| 512 | 93.753947 to | 58.890140 to | 7.603232 to |
| | 37.027813 | −0.821655 | 3.633371 |
| 510 | 93.682894 to | 58.826456 to | 7.613843 to |
| | 36.878436 | −0.760842 | 3.638302 |
| 504 | 93.705812 to | 58.931684 to | 7.633077 to |
| | 36.666918 | −0.786599 | 3.663425 |
| 498 | 93.55108 to | 59.209407 to | 7.658394 to |
| | 36.391817 | −0.659466 | 3.68139 |
| 494 | 93.488327 to | 59.344721 to | 7.658517 to |
| | 36.245642 | −0.612732 | 3.695066 |
| 492 | 93.583853 to | 59.357290 to | 7.661377 to |
| | 36.229894 | −0.717981 | 3.704184 |
| 488 | 93.505613 to | 59.337948 to | 7.668427 to |
| | 36.238294 | −0.638916 | 3.726855 |
| 406 | 92.488939 to | 52.745054 to | 7.796487 to |
| | 41.262264 | 0.255182 | 4.163612 |
| 404 | 92.51142 to | 52.661984 to | 7.79754 to |
| | 28.570245 | 0.231602 | 4.17704 |
| 402 | 92.45586 to | 52.718585 to | 7.798828 to |
| | 42.462812 | 0.267557 | 4.172035 |
| 400 | 92.367767 to | 52.877467 to | 7.79082 to |
| | 42.304403 | 0.349277 | 4.173399 |
| 398 | 92.261232 to | 53.289058 to | 7.752292 to |
| | 41.944326 | 0.513549 | 4.168947 |
| 352 | 81.526225 to | 86.752984 to | 6.652967 to |
| | 9.485169 | 11.962840 | 3.51395 |

### RESULTS AND CONCLUSIONS

Results for Clear Satin Glass:

The clear satin glass by both faces reduces visible light transmittance for glass thicknesses of 2 mm, from 87% up to 77% for a thickness of 9.5 mm, the transmittance gradually reduced as the thickness increases. While if it is only one face, there is no significant reduction in transmittance, but higher in thicknesses of 6 mm, reaching similar values to 9.5 mm (76%) in case of satin of the stained face and 84% when it is only treated the atmospheric face.

However, for values of wavelengths in the infrared range (1100 nm), the transmittance is reduced steadily from a value of 80% for thickness of 2 mm of glass, up to 63% for thicknesses of 6 mm. Something similar occurs for the treatment of only one of the two faces, although the reduction in transmittance reaches the 53% for the thickness of 6 mm.

Results of Satin, for Different Type Glass:
If applied satin to different kinds of glass, using 6 mm thick, as a reference, glossy glass displays transmittances of visible light ranging from 80% to clear satin glass up to 40% for gray satin glass.

Notably, the transmittance for infrared reduced even more for green satin glass (12%), from a value of 70% transmittance exhibited by the same satin glass in the case of visible light. Blue satin glass also exhibits significant variations in the transmittance, of 54% for visible light to 31% for infrared.

Similar trends are observed for satin glass of only one of the two faces.

Results of Roughness of Different Type of Glass:

Roughness measurements were made on samples of glass, using a TR Surface Roughness Tester, brand Time.

From the photographs you can see a remarkably homogeneous roughness, so the resulting satin-matte finish glass is a uniform finish perfectly homogeneous, a soft and touch smooth with a pleasant aspect to the eye, which do not have, like other satin glasses.

Advantages

By the thermal characteristics and the obtained results of tests carried out by the glossy glass of this invention, one obtains a surprisingly satin glass with excellent capture sunlight for applications in photovoltaic cells and solar heaters, because we can apply different treatments for different types of filters for different wavelength ranges of the electromagnetic spectrum. And in the treatment of satin-matte finish on both faces of the glass sheet, get a glass with excellent properties for application as a thermal insulator, and not let infrared light but it let the visible and ultraviolet light.

Many applications for such glass exist in a variety of industries and areas, including the construction industry, at home, in decorations, in the glass industry, etc., in which need glasses satin-matte finish glasses with a perfectly uniform finished and a soft and touch smooth with an appearance pleasing to the eye and with defined values of transmittance, absorbance, reflectance and roughness, with no other satin glass, currently known.

What is claimed is:

1. A satin-matte finish glass product comprising:
A roughness Ra of 1.04 to 4.07 and a roughness Rz of 6.7 to 23.2 and
A (%) of transmittance, a (%) of Absorbance (%) and Reflectance as follows:

| Wavelength | Transmittance | Absorbance | Reflectance |
|---|---|---|---|
| λ | (%) | (%) | (%) |
| 1200 | 12.56139 to | 12.707311 to | 2.972055 to |
| | 81.296597 | 83.935142 | 6.044448 |
| 768 | 25.891355 to | 5.709674 to | 3.346444 to |
| | 87.898596 | 70.393580 | 6.443276 |
| 720 | 34.61519 to | 4.040366 to | 3.960891 to |
| | 89.423691 | 61.455606 | 7.322774 |
| 718 | 35.025276 to | 3.953403 to | 3.600169 to |
| | 89.518513 | 55.434943 | 6.629092 |
| 714 | 89.699694 to | 60.182441 to | 6.645253 to |
| | 35.850942 | 3.741442 | 3.628573 |
| 712 | 89.694905 to | 59.762148 to | 6.614862 to |
| | 36.257736 | 3.743152 | 3.644698 |
| 710 | 89.747533 to | 59.350244 to | 6.667825 to |
| | 42.803583 | 3.688802 | 4.027526 |
| 708 | 89.893135 to | 58.904344 to | 6.659311 to |
| | 37.088171 | 3.546284 | 3.671819 |
| 706 | 89.920716 to | 58.474767 to | 6.675685 to |
| | 37.499234 | 3.497781 | 3.687479 |
| 532 | 93.746683 to | 58.259737 to | 7.542765 to |
| | 37.70885 | −0.767606 | 3.639551 |
| 526 | 93.662159 to | 58.847215 to | 7.565384 to |
| | 37.141857 | −0.692053 | 3.625793 |
| 518 | 93.716698 to | 58.957378 to | 7.5887 to |
| | 37.033218 | −0.776725 | 3.629727 |
| 516 | 93.652153 to | 58.961731 to | 7.596881 to |
| | 37.027553 | −0.713193 | 3.628661 |
| 514 | 93.717187 to | 58.910981 to | 7.604888 to |
| | 37.075171 | −0.780230 | 3.634535 |
| 512 | 93.753947 to | 58.890140 to | 7.603232 to |
| | 37.027813 | −0.821655 | 3.633371 |
| 510 | 93.682894 to | 58.826456 to | 7.613843 to |
| | 36.878436 | −0.760842 | 3.638302 |
| 504 | 93.705812 to | 58.931684 to | 7.633077 to |
| | 36.666918 | −0.786599 | 3.663425 |
| 498 | 93.55108 to | 59.209407 to | 7.658394 to |
| | 36.391817 | −0.659466 | 3.68139 |
| 494 | 93.488327 to | 59.344721 to | 7.658517 to |
| | 36.245642 | −0.612732 | 3.695066 |
| 492 | 93.583853 to | 59.357290 to | 7.661377 to |
| | 36.229894 | −0.717981 | 3.704184 |
| 488 | 93.505613 to | 59.337948 to | 7.668427 to |
| | 36.238294 | −0.638916 | 3.726855 |
| 406 | 92.488939 to | 52.745054 to | 7.796487 to |
| | 41.262264 | 0.255182 | 4.163612 |
| 404 | 92.51142 to | 52.661984 to | 7.79754 to |
| | 28.570245 | 0.231602 | 4.17704 |
| 402 | 92.45586 to | 52.718585 to | 7.798828 to |
| | 42.462812 | 0.267557 | 4.172035 |
| 400 | 92.367767 to | 52.877467 to | 7.79082 to |
| | 42.304403 | 0.349277 | 4.173399 |
| 398 | 92.261232 to | 53.289058 to | 7.752292 to |
| | 41.944326 | 0.513549 | 4.168947 |
| 352 | 81.526225 to | 86.752984 to | 6.652967 to |
| | 9.485169 | 11.962840 | 3.51395 |

2. A satin-matte finish glass according to claim 1, wherein the glass is selected from flat sheets of glass of any thickness, color and size.

3. A satin-matte finish glass according to claim 2, wherein the glass is selected from clear glass, blue, green, bronze and sun-filtering glass in thicknesses of 9.5 mm, 6 mm, 4 mm, 3 mm and 2 mm.

4. A satin-matte finish glass according to claim 1, wherein the glass is a blue satin-matte finish glass, of 6 mm by two faces having the following values:

| Wavelength | Transmittance | Absorbance | Reflectance |
|---|---|---|---|
| λ | (%) | (%) | (%) |
| 1200 | 31.372934 | 64.660095 | 3.998963 |
| 768 | 49.049349 | 46.457290 | 4.529598 |
| 404 | 67.108025 | 27.224954 | 5.718487 |
| 402 | 66.898015 | 27.438183 | 5.715239 |
| 352 | 21.331969 | 74.321201 | 4.41751 |

5. A satin-matte finish glass according to claim 1 the glass is a clear satin-matte finish glass of 9.5 mm by two faces having the following values:

| Wavelength | Transmittance | Absorbance | Reflectance |
|---|---|---|---|
| λ | (%) | (%) | (%) |
| 1200 | 49.033639 | 46.582841 | 4.418871 |
| 768 | 60.069419 | 34.629035 | 5.3443 |
| 518 | 77.949154 | 14.567755 | 7.55105 |
| 488 | 77.028676 | 15.429307 | 7.610512 |
| 352 | 44.122508 | 50.707328 | 5.254232 |

6. A satin-matte finish glass according to claim 1 the glass is a clear satin-matte finish glass of 4 mm by two faces has the following values:

| Wavelength | Transmittance | Absorbance | Reflectance |
|---|---|---|---|
| λ | (%) | (%) | (%) |
| 1200 | 69.714506 | 24.864735 | 5.464475 |
| 768 | 76.001305 | 17.803862 | 6.244791 |
| 532 | 83.009549 | 9.515571 | 7.542765 |
| 402 | 79.54126 | 12.730101 | 7.798828 |
| 352 | 63.041881 | 30.818024 | 6.239934 |

7. A satin-matte finish glass according to claim 1 wherein the glass is a green satin-matte finish glass of 6 mm by two faces having the following values:

| Wavelength | Transmittance | Absorbance | Reflectance |
|---|---|---|---|
| λ | (%) | (%) | (%) |
| 1200 | 12.56139 | 83.935142 | 3.531722 |
| 768 | 25.891355 | 70.393580 | 3.745025 |
| 514 | 70.938356 | 23.263093 | 5.851212 |
| 498 | 70.268567 | 23.922100 | 5.862092 |
| 352 | 9.485169 | 86.752984 | 3.823015 |

8. A satin-matte finish glass according to claim 1 wherein the glass is a clear satin-matte finish glass of 6 mm by two faces having the following values:

| Wavelength | Transmittance | Absorbance | Reflectance |
|---|---|---|---|
| λ | (%) | (%) | (%) |
| 1200 | 57.768439 | 37.600626 | 4.668281 |
| 768 | 67.624158 | 26.916992 | 5.502873 |
| 518 | 80.308175 | 12.776613 | 6.978014 |
| 402 | 77.548383 | 15.316987 | 7.199425 |
| 352 | 58.741911 | 35.537383 | 5.813726 |

9. A satin-matte finish glass according to claim 1 wherein the glass is a bronze satin-matte finish glass of 6 mm by two faces having the following values:

| Wavelength | Transmittance | Absorbance | Reflectance |
|---|---|---|---|
| λ | (%) | (%) | (%) |
| 1200 | 36.241169 | 59.754976 | 4.036144 |
| 710 | 54.432016 | 40.551236 | 5.057206 |
| 708 | 54.520701 | 40.464869 | 5.054869 |
| 402 | 42.462812 | 52.718585 | 4.862364 |
| 352 | 10.905156 | 85.047813 | 4.112836 |

10. A satin-matte finish glass according to claim 1 wherein the glass is a sun-filtering satin-matte finish glass of 6 mm by two faces having the following values:

| Wavelength | Transmittance | Absorbance | Reflectance |
|---|---|---|---|
| λ | (%) | (%) | (%) |
| 1200 | 32.405953 | 63.924501 | 3.699139 |
| 714 | 52.779966 | 42.655211 | 4.601636 |
| 712 | 52.755428 | 42.674022 | 4.607409 |
| 402 | 45.380058 | 50.082564 | 4.578585 |
| 352 | 13.050861 | 83.232472 | 3.777101 |

11. A satin-matte finish glass according to claim 1 wherein the glass is a clear satin-matte finish glass of 2 mm by two faces having the following values:

| Wavelength | Transmittance | Absorbance | Reflectance |
|---|---|---|---|
| λ | (%) | (%) | (%) |
| 1200 | 77.235 | 17.115996 | 5.69456 |
| 714 | 84.195213 | 9.212696 | 6.645253 |
| 532 | 87.541782 | 5.052942 | 7.472529 |
| 406 | 85.198044 | 7.112205 | 7.759587 |
| 352 | 73.081519 | 6.652967 | 20.371961 |

12. A satin-matte finish glass according to claim 1 wherein the glass is a green satin-matte finish glass of 6 mm atmospheric face, having the following values:

| Wavelength | Transmittance | Absorbance | Reflectance |
|---|---|---|---|
| λ | (%) | (%) | (%) |
| 1200 | 15.853307 | 81.198414 | 2.972055 |
| 714 | 41.918366 | 54.482090 | 3.628573 |
| 514 | 78.582455 | 16.125532 | 5.340074 |
| 510 | 78.475325 | 16.221995 | 5.350838 |
| 352 | 12.446269 | 84.077958 | 3.53229 |

13. A satin-matte finish glass according to claim 1 wherein the glass is a sun-filtering satin-matte finish glass of 6 mm atmospheric face, having the following values:

| Wavelength | Transmittance | Absorbance | Reflectance |
|---|---|---|---|
| λ | (%) | (%) | (%) |
| 1200 | 40.075193 | 56.553311 | 3.398685 |
| 720 | 60.529996 | 35.272361 | 4.231495 |
| 714 | 60.470018 | 35.326775 | 4.237104 |
| 510 | 39.608186 | 56.786257 | 3.638302 |
| 352 | 14.225484 | 82.316789 | 3.51395 |

14. A satin-matte finish glass according to claim 1 wherein the glass is a bronze satin-matte finish glass of 6 mm atmospheric face, having the following values:

| Wavelength | Transmittance | Absorbance | Reflectance |
|---|---|---|---|
| λ | (%) | (%) | (%) |
| 1200 | 39.945943 | 56.399722 | 3.683805 |
| 720 | 60.692286 | 34.793814 | 4.550302 |
| 708 | 61.272191 | 34.182517 | 4.581948 |
| 510 | 41.941549 | 54.073823 | 4.020815 |
| 352 | 12.36567 | 83.963287 | 3.730735 |

15. A satin-matte finish glass according to claim 1 wherein the glass is a blue satin-matte finish glass of 6 mm atmospheric face, having the following values:

| Wavelength | Transmittance | Absorbance | Reflectance |
|---|---|---|---|
| λ | (%) | (%) | (%) |
| 1200 | 32.03812 | 64.027554 | 3.966054 |
| 720 | 56.288231 | 38.729629 | 5.022319 |
| 406 | 68.340551 | 25.685927 | 6.027772 |
| 404 | 68.32067 | 25.699716 | 6.033919 |
| 352 | 21.518846 | 74.152498 | 4.399041 |

16. A satin-matte finish glass according to claim 1 wherein the glass is a clear satin-matte finish glass of 9.5 mm atmospheric face, having the following values:

| Wavelength | Transmittance | Absorbance | Reflectance |
|---|---|---|---|
| λ | (%) | (%) | (%) |
| 1200 | 53.565179 | 42.694079 | 3.770909 |
| 720 | 70.404165 | 24.997802 | 4.635114 |
| 518 | 85.127131 | 9.374478 | 5.548326 |
| 494 | 84.253143 | 10.236277 | 5.560626 |
| 352 | 48.675493 | 47.225053 | 4.166112 |

17. A satin-matte finish glass according to claim 1 the glass is a clear satin-matte finish glass of 6 mm atmospheric face, having the following values:

| Wavelength | Transmittance | Absorbance | Reflectance |
|---|---|---|---|
| λ | (%) | (%) | (%) |
| 1200 | 64.452909 | 30.967417 | 4.616607 |
| 720 | 80.431063 | 14.084781 | 5.528383 |
| 514 | 92.572828 | 1.090261 | 6.394461 |
| 402 | 90.087047 | 3.503684 | 6.467476 |
| 352 | 65.538125 | 29.421212 | 5.122625 |

18. A satin-matte finish glass according to claim 1 wherein the glass is a clear satin-matte finish glass of 2 mm atmospheric face, having the following values:

| Wavelength | Transmittance | Absorbance | Reflectance |
|---|---|---|---|
| λ | (%) | (%) | (%) |
| 1200 | 81.296597 | 12.707311 | 6.044448 |
| 720 | 89.423691 | 4.040366 | 6.588652 |
| 512 | 93.753947 | −0.821655 | 7.131895 |
| 400 | 92.367767 | 0.349277 | 7.349098 |
| 352 | 81.526225 | 11.962840 | 6.616804 |

19. A satin-matte finish glass according to claim 1 wherein the glass is a clear satin-matte finish glass of 4 mm atmospheric face, having the following values:

| Wavelength | Transmittance | Absorbance | Reflectance |
|---|---|---|---|
| λ | (%) | (%) | (%) |
| 1200 | 75.732739 | 19.031403 | 5.278083 |
| 720 | 86.848305 | 7.322774 | 5.875928 |
| 512 | 93.672018 | 0.017616 | 6.367675 |
| 404 | 92.106548 | 1.515100 | 6.436279 |
| 352 | 74.666725 | 19.907474 | 5.514025 |

20. A satin-matte finish glass according to claim 1 wherein the glass is a clear satin-matte finish glass of 3 mm atmospheric face, having the following values:

| Wavelength | Transmittance | Absorbance | Reflectance |
|---|---|---|---|
| λ | (%) | (%) | (%) |
| 1200 | 78.395095 | 15.979032 | 5.671243 |
| 720 | 87.940732 | 5.718345 | 6.392059 |
| 518 | 93.533625 | −0.510344 | 7.04008 |
| 402 | 92.067313 | 0.768631 | 7.229118 |
| 352 | 78.073423 | 15.733678 | 6.293597 |

21. A satin-matte finish glass according to claim 1 wherein the glass is a bronze satin-matte finish glass of 6 mm stained face, having the following values:

| Wavelength | Transmittance | Absorbance | Reflectance |
|---|---|---|---|
| λ | (%) | (%) | (%) |
| 1200 | 39.667245 | 56.529638 | 3.833787 |
| 708 | 59.165432 | 36.216292 | 4.65552 |
| 706 | 59.13625 | 36.239317 | 4.661727 |
| 402 | 46.847755 | 48.729100 | 4.463315 |
| 352 | 11.883955 | 84.367479 | 3.809518 |

22. A satin-matte finish glass according to claim 1 wherein the glass is a sung-filtering satin-matte finish glass of 6 mm stained face, having the following values:

| Wavelength | Transmittance | Absorbance | Reflectance |
|---|---|---|---|
| λ | (%) | (%) | (%) |
| 1200 | 36.912386 | 59.446477 | 3.670501 |
| 718 | 58.996559 | 36.626731 | 4.412006 |
| 714 | 58.999209 | 36.627326 | 4.408735 |
| 402 | 51.688854 | 44.004914 | 4.34534 |
| 352 | 12.032379 | 84.410448 | 3.615013 |

23. A satin-matte finish glass according to claim 1 wherein the glass is a clear satin-matte finish glass of 9.5 mm stained face, having the following values:

| Wavelength | Transmittance | Absorbance | Reflectance |
|---|---|---|---|
| λ | (%) | (%) | (%) |
| 1200 | 53.275541 | 42.677956 | 4.079136 |
| 718 | 66.075308 | 29.057387 | 4.906557 |
| 514 | 77.354365 | 16.932642 | 5.764877 |
| 492 | 76.488955 | 17.786832 | 5.776199 |
| 352 | 44.967471 | 50.617009 | 4.487317 |

24. A satin-matte finish glass according to claim 1 wherein the glass is a blue satin-matte finish glass of 6 mm stained face, having the following values:

| Wavelength | Transmittance | Absorbance | Reflectance |
|---|---|---|---|
| λ | (%) | (%) | (%) |
| 1200 | 32.359597 | 63.655372 | 4.017168 |
| 718 | 57.727465 | 37.303283 | 5.009327 |
| 514 | 58.533978 | 36.380409 | 5.131799 |
| 404 | 70.450059 | 23.634965 | 5.968694 |
| 352 | 22.39208 | 73.343824 | 4.333431 |

25. A satin-matte finish glass according to claim 1 wherein the glass is a clear satin-matte finish glass of 4 mm stained face, having the following values:

| Wavelength | Transmittance | Absorbance | Reflectance |
|---|---|---|---|
| λ | (%) | (%) | (%) |
| 1200 | 75.79831 | 18.813924 | 5.431216 |
| 718 | 86.706381 | 7.278846 | 6.063279 |
| 518 | 93.400827 | 0.010242 | 6.64877 |
| 400 | 91.773133 | 1.459862 | 6.828461 |
| 352 | 75.196424 | 18.960358 | 5.93823 |

26. A satin-matte finish glass according to claim 1 wherein the glass is a clear satin-matte finish glass of 6 mm stained face, having the following values:

| Wavelength | Transmittance | Absorbance | Reflectance |
|---|---|---|---|
| λ | (%) | (%) | (%) |
| 1200 | 63.23887 | 31.994332 | 4.80524 |
| 718 | 80.244873 | 14.204235 | 5.595657 |
| 504 | 91.717807 | 1.941196 | 6.398584 |
| 402 | 90.511234 | 2.984822 | 6.563011 |
| 352 | 69.612697 | 24.929985 | 5.546055 |

27. A satin-matte finish glass according to claim 1 wherein the glass is a clear satin-matte finish glass of 2 mm stained face, having the following values:

| Wavelength | Transmittance | Absorbance | Reflectance |
|---|---|---|---|
| λ | (%) | (%) | (%) |
| 1200 | 80.36294 | 13.741684 | 5.942919 |
| 526 | 92.179808 | 1.002246 | 6.879865 |
| 512 | 92.168489 | 0.979384 | 6.914356 |
| 400 | 90.813101 | 2.114745 | 7.136381 |
| 352 | 79.587209 | 13.981666 | 6.535696 |

28. A satin-matte finish glass according to claim 1 wherein the glass is a clear satin-matte finish glass of 3 mm stained face, having the following values:

| Wavelength | Transmittance | Absorbance | Reflectance |
|---|---|---|---|
| λ | (%) | (%) | (%) |
| 1200 | 77.276597 | 16.981463 | 5.788246 |
| 516 | 92.845968 | 0.348715 | 6.867121 |
| 504 | 92.830179 | 0.332062 | 6.899858 |
| 398 | 91.098645 | 1.955004 | 7.0593 |
| 352 | 77.159543 | 16.574801 | 6.367537 |

29. A satin-matte finish glass according to claim 1 produced by a process comprising:
a) providing a piece or sheet of glass;
b) loading the piece or sheet of glass into a container;
c) processing of the piece or sheet of glass by immersion in the following stages:
i. pre-treating in a washing and cleaning solution;
ii. immersing in an acid solution for satin-matte finish;
iii. immersing in a current of water to rinse and then rinse by spraying with deionized water;
iv. immersing in an acid solution to stop the reaction and ensure the finish satin-matte finish;
v. immersing in a current of water to rinse and then rinse by spraying with deionized water;
vi. immersing in deionized water for washing and then spraying with deionized water;
d) drying of the piece or sheets of glass;
e) downloading the piece or satin-matte finish sheets of glass to the container to storage racks for storage, transport and distribution.

30. A satin-matte finish glass according to claim 29 wherein the stages in immersion comprise:
i)—a pre-treatment stage using a washing and cleaning solution composed of 55% deionized water at least 10 microhms, 5% hydrofluoric acid 70%, ie 3.5% acid and 1.5% water and 39.5% sugar dextrose monohydrate, to eliminate all foreign substances to the glass;
ii)—am immersion in an acid solution for satin-matte finish that contains 3 to 8% hydrofluoric acid at 70%, equivalent from 2.1% to 5.6% of total hydrofluoric acid, 3 to 8% hydrochloric acid at 30%, equivalent from 0.9% to 2.4% total hydrochloric acid, from 10 to 30% formic acid 85%, equivalent from 8.5% to 25.5% of the total formic acid, 20 to 40% of deionized water at least 10 microhms, 20 50% of anhydrous ammonium bifluoride and 5 to 25% sugar dextrose monohydrate, the speed of immersion is 5.2 meters/minute and the immersion time is from 5 minutes to 30 minutes.
iii)—an immersion to rinse and to eliminate the rest of the previous acid solution, which is done by immersion in water and then spraying with deionized water.
iv)—an immersion to stop the chemical reaction on the glass and remove all traces of the acid solution that may exist that contains 3 to 5% hydrochloric acid at 30%, equivalent from 0.9% to 1.5% of the hydrochloric total acid, 3 to 5% hydrofluoric acid at 70%, equivalent from 2.1% to 3.5% of total hydrofluoric acid and water from 95 to 97%, this solution should be between 0.5 and 1.0 milliequivalents per liter, a pH of 2.1 to 3.2, the time immersion varies from 30 seconds to 3 minutes depending on the number of sheets of glass.
v)—an immersion to rinse and to eliminate the acid solution above, which is done by immersion in water and then spraying with deionized water;
vi)—an immersion to wash and to eliminate the remains of the acid solution, which is done by immersion in deionized water and then by spraying deionized water and
vii)—am immersion in case of any eventuality or necessity can be water or acid solution.

31. A satin-matte finish glass according to claim 29 wherein the drying of the pieces or sheets of glass is done in a drying chamber at a temperature of 30 to 60° C., or can also be done to the environment temperature, or through a washer/dryer vertically or horizontally, or through a tunnel furnace type, operated with natural gas, LP gas or electrical resistance, without affecting the quality of the glass.
